(19) United States
(12) Patent Application Publication
(10) Pub. No.: US 2026/0112200 A1
(43) Pub. Date: Apr. 23, 2026

(54) INFORMATION PROCESSING APPARATUS, METHOD FOR INFORMATION PROCESSING APPARATUS, AND STORAGE MEDIUM

(71) Applicant: CANON KABUSHIKI KAISHA, Tokyo (JP)

(72) Inventors: Koji MAKITA, Kanagawa (JP); Shunta TATE, Tokyo (JP)

(21) Appl. No.: 19/356,522

(22) Filed: Oct. 13, 2025

(30) Foreign Application Priority Data
Oct. 21, 2024 (JP) 2024-185006

(51) Int. Cl. G06V 40/16

(52) U.S. Cl. CPC G06V 40/172

(57) ABSTRACT

An information processing apparatus registers a face image of a person, performs authentication to authenticate a person using an input face image and the registered face image, calculates a matching rate between the input face image and the registered face image, determines whether a possibility exists that the person in the input face image is identical to the person in the registered face image based on a result of the authentication and the matching rate, and outputs information corresponding to a result of the determination.

### BACKGROUND

### Field of the Technology

The present disclosure relates to an information processing apparatus, a method for an information processing apparatus, and a storage medium that perform re-imaging in a case where the authentication result of a face authentication apparatus results in unauthentication.

### Description of the Related Art

An image-based face authentication system sometimes compares pre-registered face images with a face image of an authentication target person to determine whether the face image of the authentication target person is identical to any pre-registered face images. Because of the quality of the face image of the authentication target person, the face authentication may have a result of unauthentication even though the face image of the authentication target person has been registered. Japanese Patent Laid-Open No. 2019-040642 discloses a technique for improving the quality of face images by improving an imaging method by presenting a guidance regarding the action to be taken by an authentication target person when the face authentication results in unauthentication. The technique described in Japanese Patent Laid-Open No. 2019-040642 presents a re-imaging guidance assuming that the authentication target person is a pre-registered person.

Useless re-imaging or mis-authentication may occur in a case where the authentication target person is not a person registered in advance.

### SUMMARY

In view of the above, the present disclosure is directed to reducing the occurrence of re-imaging or mis-authentication in a case where the authentication results in unauthentication.

According to an aspect of the present disclosure, an information processing apparatus includes at least one memory storing instructions and at least one processor that, when executing the instructions, causes the information processing apparatus to register a face image of a person, perform authentication to authenticate a person using an input face image and the registered face image, calculate a matching rate between the input face image and the registered face image, determine whether a possibility exists that a person in the input face image is identical to a person in the registered face image based on a result of the authentication and the matching rate, and output information corresponding to a result of the determination.

Features of the present disclosure will become apparent from the following description of embodiments with reference to the attached drawings. The following description of embodiments is described by way of example.

### BRIEF DESCRIPTION OF THE DRAWINGS

FIG. 1 illustrates an example configuration of an image processing apparatus according to a first embodiment.

FIG. 2 is a flowchart illustrating an example of processing for determining the identity likelihood according to the first embodiment.

FIG. 3 illustrates an example of an image captured in step S200 of FIG. 2.

FIG. 4 illustrates an example of an image generated in step S201 of FIG. 2.

FIG. 5 illustrates an example of information presented in step S206 of FIG. 2.

FIG. 6 illustrates an example of processing for determining a threshold value to be used in step S201 of FIG. 2.

FIG. 7 is a scatter diagram illustrating a frequency distribution of pairs of face images of identical persons.

FIG. 8 illustrates an example of processing for determining a threshold value to be used in step S204 of FIG. 2.

FIG. 9 illustrates an example of a scatter diagram illustrating pairs of face images.

FIG. 10 is a schematic view illustrating the division of face images into rectangular regions.

FIG. 11 is a schematic view illustrating an investigation of the number of pairs of corresponding face-including rectangular regions in two different face images.

FIG. 12 is a schematic view illustrating a result of extracting face-including pixels from face images.

FIG. 13 is a schematic view illustrating a result of overlapping the two face regions on one image region.

FIG. 14 is a schematic view illustrating a result of detecting facial organ positions from two different face images.

FIG. 15 is a schematic view illustrating a result of associating the facial organ positions detected from the two face images.

FIG. 16 illustrates examples of target positions of facial organs.

FIG. 17 illustrates examples of images generated by normalizing two different face images.

FIG. 18 is a schematic view illustrating a result of drawing facial organ positions on the two face images.

FIG. 19 is a schematic view illustrating a distance between the centers of the right eyes on the two face images.

FIG. 20 is a flowchart illustrating an example of detailed processing in step S204 of FIG. 2.

FIG. 21 illustrates an example of a scatter diagram of pairs of face images.

FIG. 22 illustrates a class division line in the scatter diagram in FIG. 21.

FIG. 23 illustrates the division of a region having a face similarity less than or equal to a predetermined value in the scatter diagram in FIG. 21 into a plurality of regions.

FIG. 24 is a flowchart illustrating an example of processing for calculating a matching rate.

FIG. 25 illustrates an example of a method for displaying a matching result with a pre-registered face image not displayed.

FIG. 26 illustrates an example of a method for displaying a matching result with the pre-registered face image blurred.

FIG. 27 illustrates an example of a method for displaying a matching result using an illustration based on a pre-registered face image.

### DESCRIPTION OF THE EMBODIMENTS

Embodiments of the present disclosure will be described in detail below with reference to the accompanying drawings. Configurations described in the following embodiments are to be considered as illustrative, and the present disclosure is not limited to the illustrated configurations.

### First Embodiment

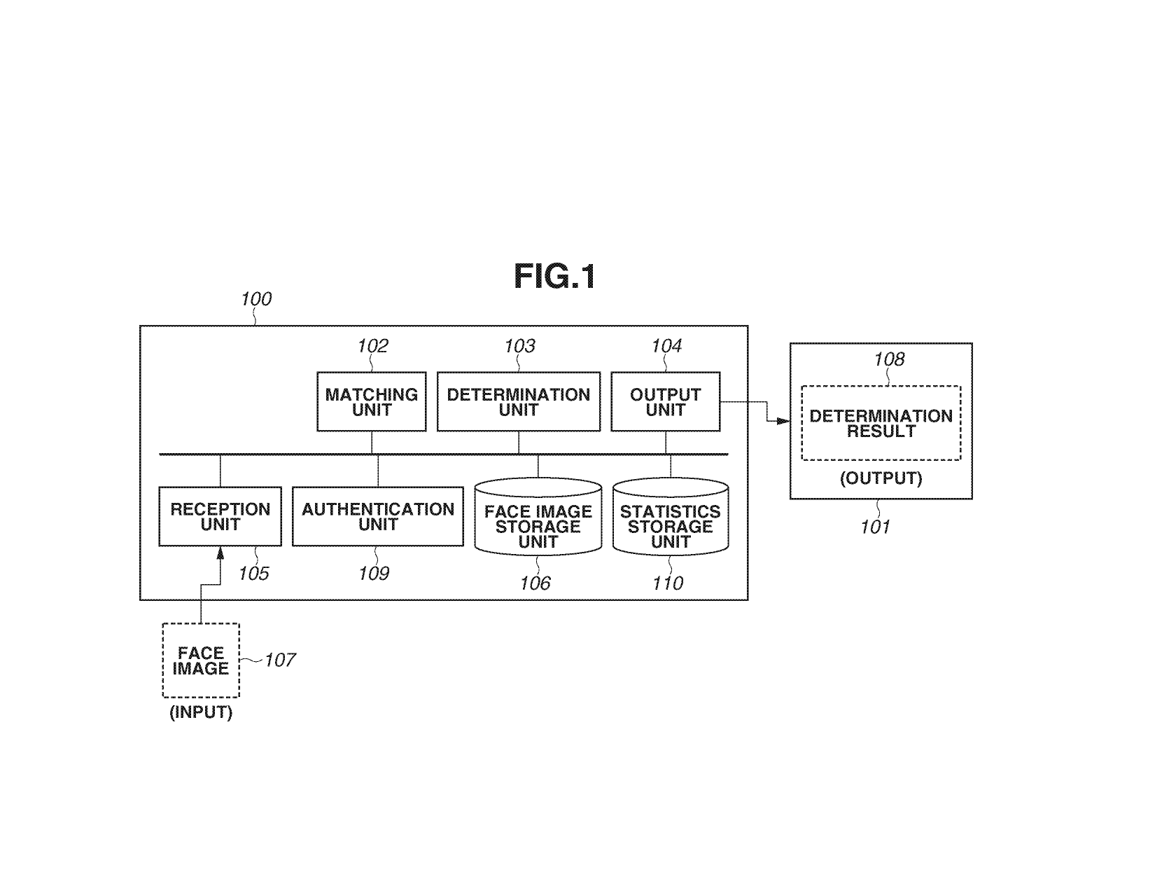

A first embodiment will be described with respect to an information processing apparatus having an authentication function, and a function of determining the possibility that an authentication target person is identical to a pre-registered person (hereinafter also referred to as the identity likelihood) and displaying a result of the determination. The information processing apparatus according to the present embodiment will be described with reference to FIGS. 1 to 9.

FIG. 1 illustrates an example configuration of the information processing apparatus according to the present embodiment. An image processing apparatus 100 is an example of an information processing apparatus and includes a matching unit 102, a determination unit 103, an output unit 104, a reception unit 105, an authentication unit 109, a face image storage unit 106, and a statistics storage unit 110. These units are connected via a bus.

The reception unit 105 receives a face image 107 input from external to the image processing apparatus 100.

The received face image 107 is stored in the face image storage unit 106.

Registered face images are stored in advance in the face image storage unit 106.

The authentication unit 109 uses the registered face images stored in the face image storage unit 106 and the face image 107 to generate an authentication result for a person of whom face images are registered and the person appearing in the face image 107.

The matching unit 102 performs matching processing between the registered face images, which are stored in the face image storage unit 106 in advance, and the input face image 107. The matching unit 102 calculates a matching rate between the registered face images and the face image 107, and sends the calculated matching rate to the determination unit 103. The matching rate refers to a value by indexing the degree of a spatial correlation between two different faces, obtained by calculating the correlation and consistency between regions and organ points of the two face images.

The statistics storage unit 110 stores statistical values (described below) in advance.

The determination unit 103 determines, based on the statistical values stored in the statistics storage unit 110, the authentication result received from the authentication unit 109, and the matching rate received from the matching unit 102, whether the registered face images include an image reflecting the same person as the person appearing in the face image 107. The determination unit 103 transmits the determination result to the output unit 104.

The output unit 104 outputs the determination result received from the determination unit 103 external to the image processing apparatus 100. A determination result 108 externally output is displayed, for example, on the display unit 101 external to the image processing apparatus 100.

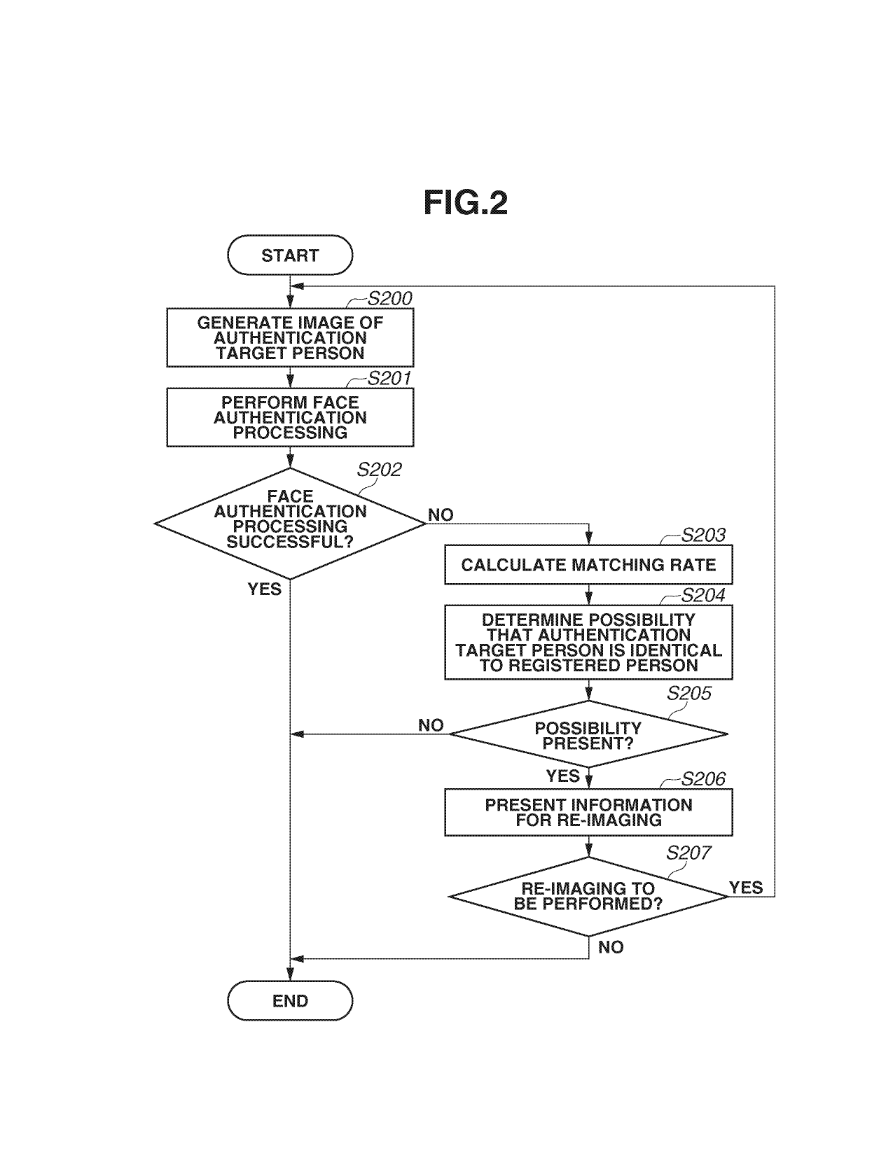

An example of processing for generating the determination result 108 using an image processing system including the image processing apparatus 100 will be described with reference to FIGS. 2 to 5.

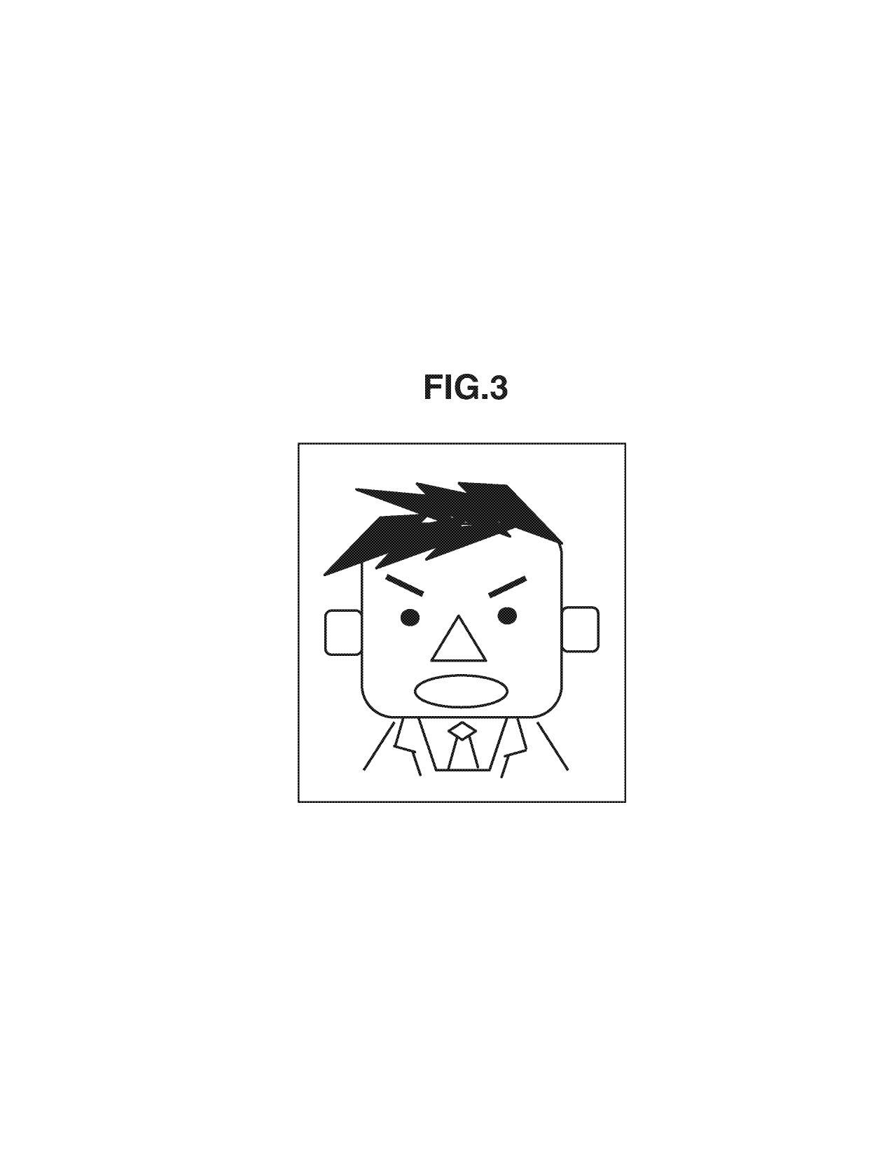

Turning to FIG. 2, in step S200, the image processing apparatus 100 generates an image of an authentication target person. More specifically, the image processing apparatus 100 captures an image of the authentication target person with a camera. FIG. 3 illustrates an example of a generated image. The image processing apparatus 100 captures an image of the authentication target person such that the image includes the entire face region of the authentication target person.

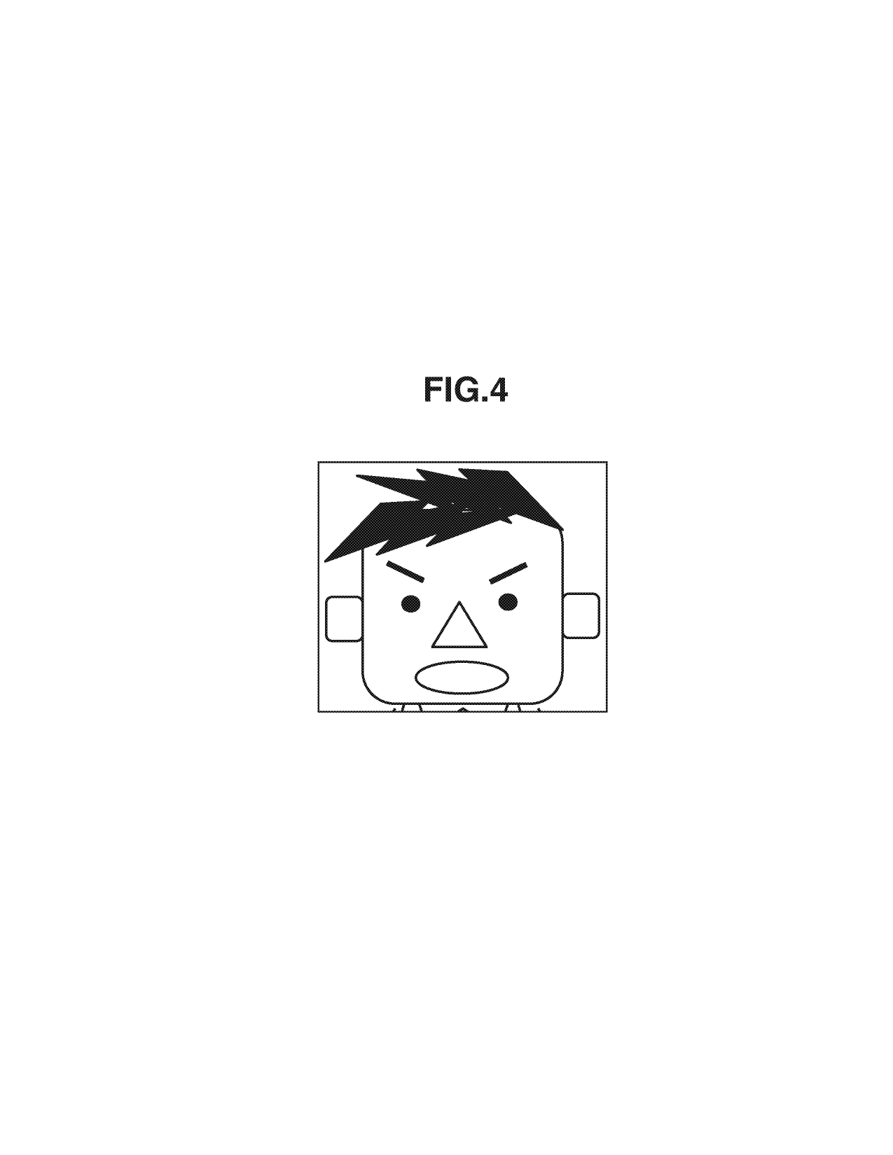

In step S201, the image processing apparatus 100 performs face authentication processing for the authentication target person by using the image of the authentication target person generated in step S200 and a pre-registered face image. According to the present embodiment, the image processing apparatus 100 uses an authentication method based on a partial image, which is a rectangular region substantially circumscribing the facial region within the image. The image processing apparatus 100 clips a face-including rectangular region from the image captured in step S200 via image processing with a face detector, and generates a face image of the authentication target person. FIG. 4 illustrates an example of the generated face image. The generated image is input to the image processing apparatus 100 as the face image 107. The image processing apparatus 100 then compares the face image 107 with a plurality of face images registered in the image processing apparatus 100 to calculate the similarities of the registered face images, and obtains the highest similarity value. In this case, the plurality of registered face images stored in the image processing apparatus 100 is a partial image including a rectangular region substantially circumscribing the facial region. When the highest similarity value between the input face image and the registered face images is greater than or equal to a predetermined threshold value, the image processing apparatus 100 determines that the person appearing in the registered face image having the highest similarity value is identical to the authentication target person, and determines that the authentication processing is successful. When the highest similarity value obtained in this processing is less than the predetermined value, the image processing apparatus 100 determines that the authentication processing has failed. The present embodiment uses the method described in Minchul Kim, et al, "AdaFace: Quality Adaptive Margin for Face Recognition", in CVPR 2022, arXiv: 2204.00964 (hereinafter referred to as “Non-Patent Document 1”) as a method for calculating the similarities. The specific method is not limited thereto, and other methods are also applicable. A method for determining the threshold value used in this processing will be separately described in detail below.

In step S202, the image processing apparatus 100 determines whether the face authentication processing performed in step S201 is successful. In a case where the face authentication processing is successful (YES in step S202), the processing ends. In a case where the face authentication processing fails (NO in step S202), the processing proceeds to step S203.

In step S203, the image processing apparatus 100 calculates the matching rate between the face image of the authentication target person and the registered face image having the highest similarity with the face image. To calculate the matching rate, the present embodiment uses a dense matching method for densely estimating corresponding points between images. More specifically, the present embodiment detects pairs of corresponding points between images by using the method described in Jiaming Sun, et al, "LoFTR: Detector-Free Local Feature Matching with Transformers", in CVPR 2021, arXiv: 2104.00680 (hereinafter referred to as “Non-Patent Document 2”), and determines the number of detected pairs as the matching rate. The matching technique is not limited thereto. Other methods for estimating matched points or matched regions between two different objects appearing in an image are also applicable. The face of a person is formed of characteristic portions such as the eyes, nose, mouth, and cheeks. Even when the appearances of faces are different between two different images under comparison, matched points or regions exist between the two face images. The image processing apparatus 100 may calculate the matching rate by using the number or ratio of matched points or regions.

In step S204, the image processing apparatus 100 determines, based on the size relationship between the matching rate calculated in step S203 and the predetermined threshold value, the possibility that the authentication target person is identical to a pre-registered person, i.e., a person of whom face images are registered. In a case where the matching rate calculated in step S203 is less than the threshold value, the image processing apparatus 100 determines that the possibility exists that the authentication target person is identical to a pre-registered person. Even if the authentication target person is identical to a pre-registered person, there may be a case where an authentication failure is determined because, for example, images of the front and side faces are used in the authentication processing. In a case where the maximum value of the matching rate calculated in step S203 is greater than or equal to the threshold value, the image processing apparatus 100 determines that the possibility does not exist that the authentication target person is identical to a registered person.

In step S205, the image processing apparatus 100 determines, based on the results of the determination performed in step S204, whether the possibility exists that the authentication target person may be identical to a registered person. In a case where the possibility exists that the authentication target person may be identical to a registered person (YES in step S205), the processing proceeds to step S206. In a case where the possibility does not exist that the authentication target person may be identical to a registered person (NO in step S205), the processing ends.

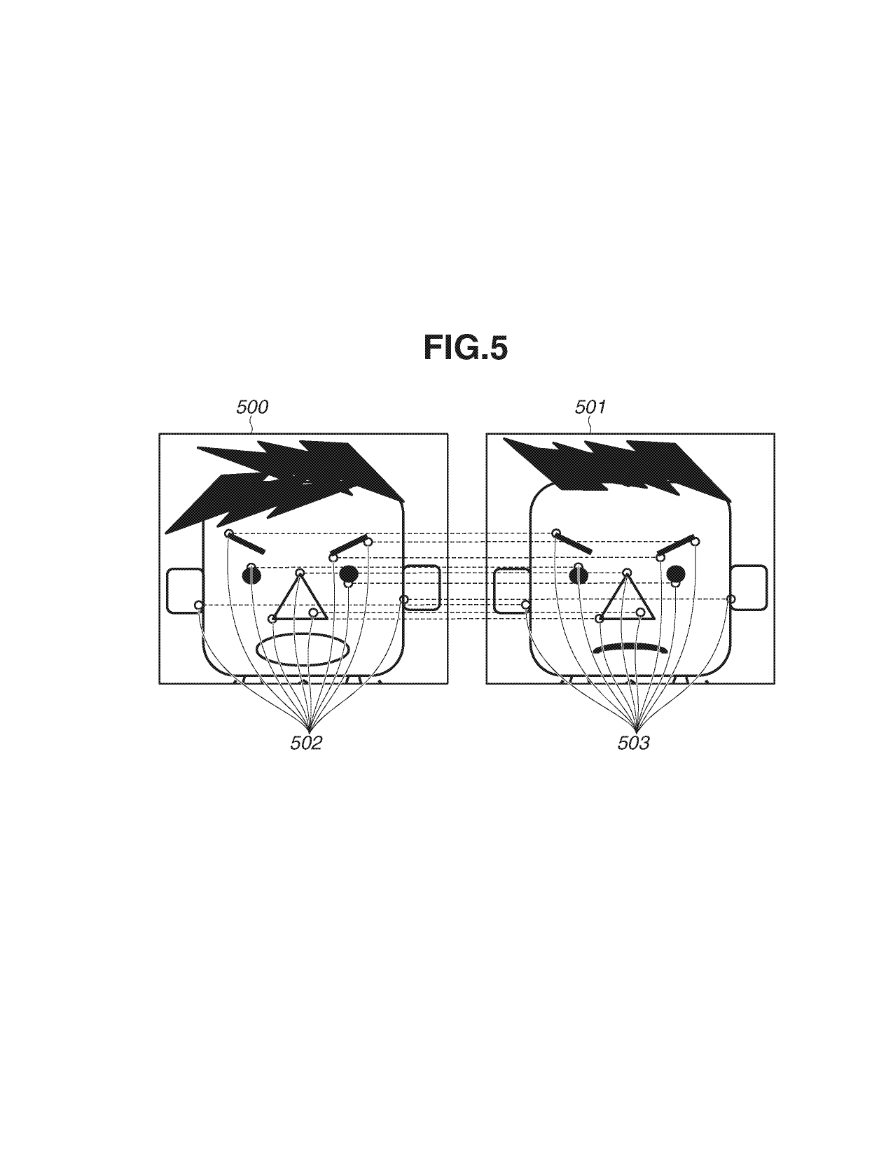

In step S206, the image processing apparatus 100 presents information for re-imaging of the authentication target person to the authentication target person. The image processing apparatus 100 generates, based on the result of the matching for densely estimating corresponding points between images through the dense matching method used in step S203, the information to be presented to the authentication target person. FIG. 5 illustrates an example of the information to be presented. An image 500 is a face image of the authentication target person generated in step S201 and an image 501 is the registered face image having the highest similarity with the image 500 in step S201. Point groups 502 and 503 are sets of points that form pairs of corresponding points detected from the images 500 and 501. The information illustrated in FIG. 5 enables the authentication target person to know how re-imaging is to be performed to achieve successful authentication. To prevent the authentication result from being erroneously determined to be an authentication failure, the matching rate needs to be improved by increasing the number of pairs of corresponding points between face images. For example, the presentation of the information in FIG. 5 enables the authentication target person to know that image portions around the mouth and bangs are mismatched. This is because of a large difference between the pre-registered image and the current captured image at each of mismatched portions. This means that, at the time of re-imaging, the authentication target person needs to try and ensure that facial portions around the mouth and bangs are more likely to be matched. For example, the authentication target person needs to raise the bangs and close the mouth.

Returning to FIG. 2, in step S207, the image processing apparatus 100 determines whether re-imaging is to be performed depending on whether to perform re-imaging of the authentication target person. In a case where re-imaging of the authentication target person is to be performed (YES in step S207), the processing returns to step S200. In a case where re-imaging of the authentication target person is not to be performed (NO in step S207), the processing ends.

In step S203, the image processing apparatus 100 compares the face image of the authentication target person generated in step S201 with the registered face image having the highest similarity in step S201 to calculate the matching rate. However, the target of the matching rate calculation is not limited thereto. The image processing apparatus 100 may calculate the matching rates between the registered face images and the face image of the authentication target person after selecting a plurality of registered face images, and use the maximum value of the calculated matching rates.

With a plurality of images of an identical person captured from various angles and pre-registered, the image processing apparatus 100 may also calculate the maximum value of the matching rates for all of the plurality of images of the person corresponding to the registered face image having the highest similarity in step S201 as the matching rate calculation target.

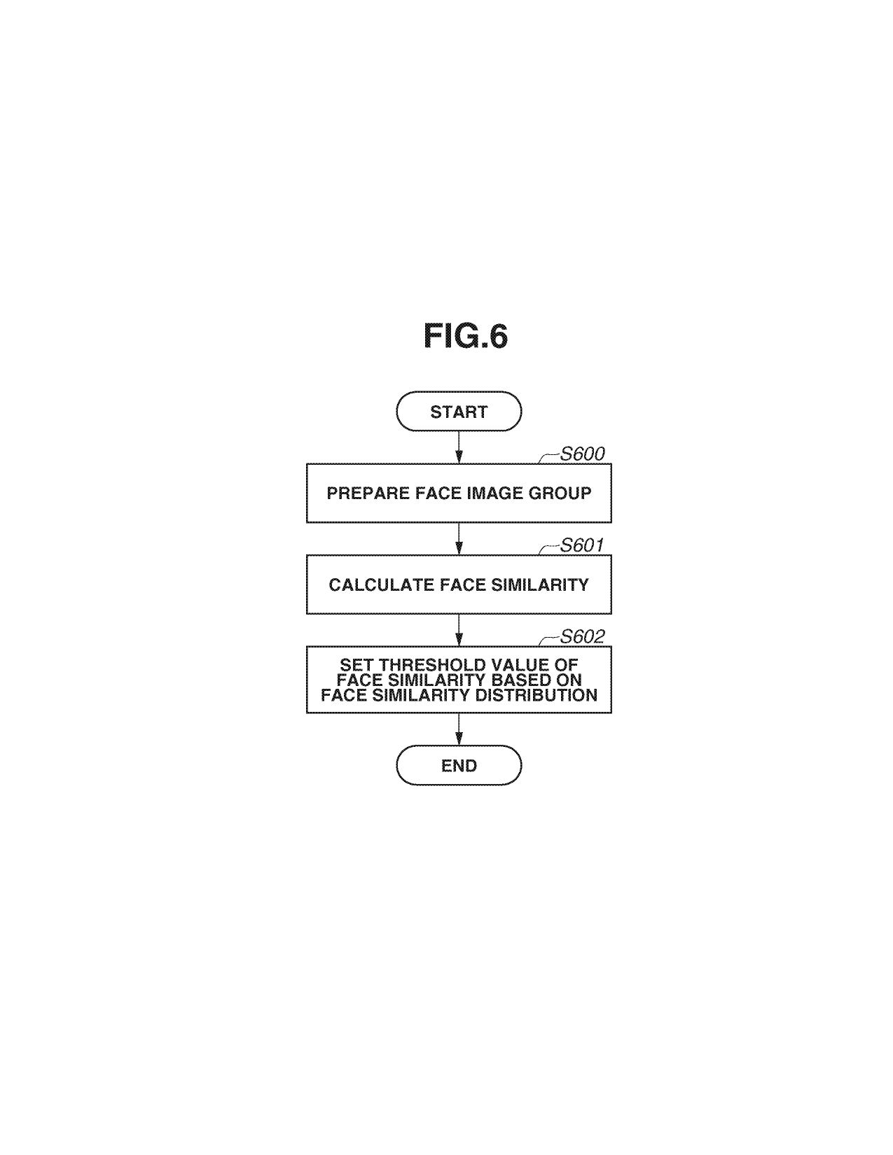

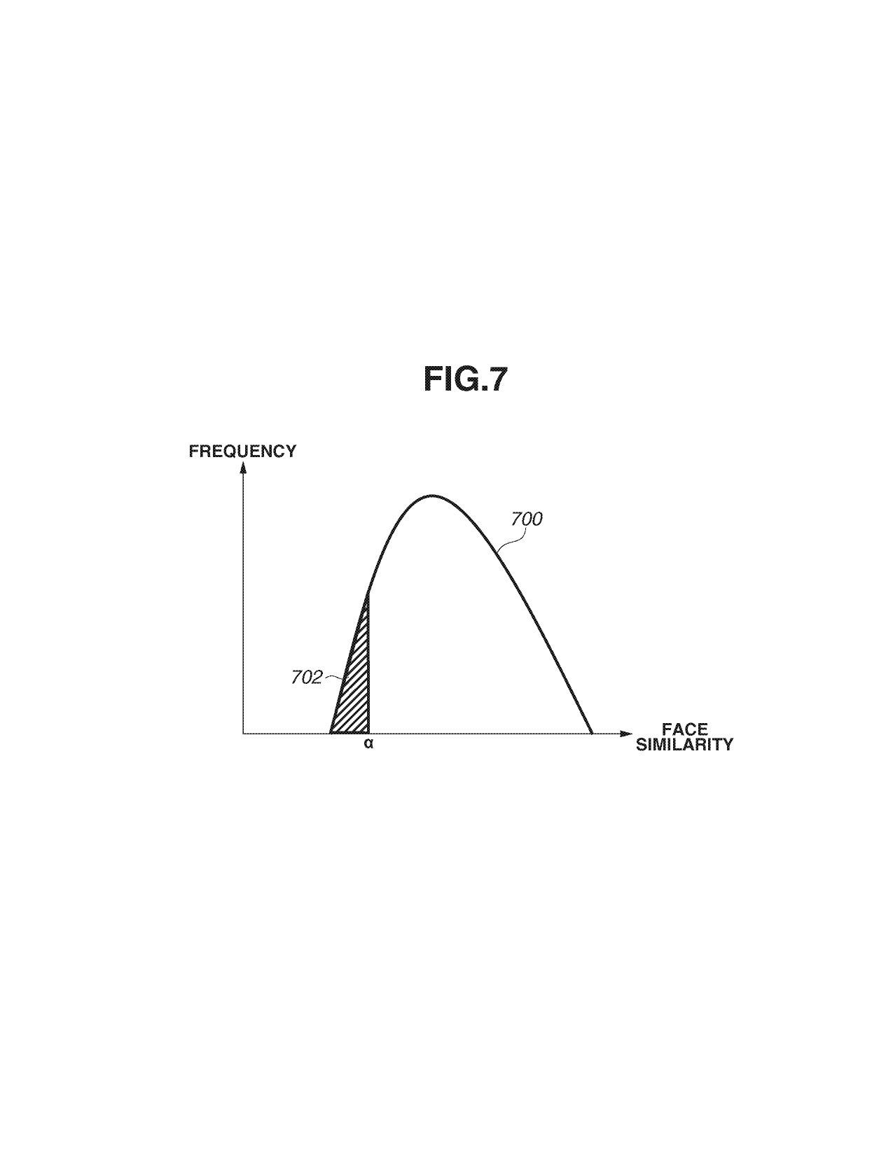

A method for determining the threshold value for the face authentication processing used in step S201 will be described with reference to FIGS. 6 and 7. FIG. 6 illustrates an example of processing for determining the threshold value. FIG. 7 is a chart illustrating a frequency distribution in which the horizontal axis represents the face similarity and the vertical axis represents the frequency of face image pairs.

Turning to FIG. 6, in step S600, the image processing apparatus 100 prepares a face image group. For description purposes, the image processing apparatus 100 prepares 10 images for each of 100 persons.

In step S601, the image processing apparatus 100 calculates the face similarities based on the face image group prepared in step S600. The image processing apparatus 100 calculates the face similarity for each of the face image pairs of identical persons that can be generated from the image group prepared in step S600. There are 10 face images for each of 100 persons, where the number of face image pairs of identical persons is 4,500. As an example of a method for calculating the similarity between two different faces, the image processing apparatus 100 uses the method described in Non-Patent Document 1 used in step S201. The image processing apparatus 100 stores the calculated face similarities in the statistics storage unit 110.

In step S602, the image processing apparatus 100 sets a threshold value of the face similarities for identification. The image processing apparatus 100 determines a threshold value α of the face similarities used to determine whether persons appearing in two different images are an identical person based on the distribution of the face similarities calculated in step S601. According to the present embodiment, the threshold value is set such that the probability that a pair of the face images of an identical person is erroneously determined to be a pair of the face images of different persons is 0.1 (hereinafter this probability is referred to as an unauthentication rate). The threshold value can be determined based on different criteria or methods.

An example of the processing in step S602 will be described in detail with reference to FIG. 7. As illustrated in FIG. 7, the image processing apparatus 100 generates a frequency distribution in which the horizontal axis represents the face similarity and the vertical axis represents the frequency of face image pairs. FIG. 7 illustrates a frequency distribution 700 of 4,500 pairs of face image of identical persons. The image processing apparatus 100 calculates a product M of the total number of pairs included in the frequency distribution 700 and the unauthentication rate, i.e., the number of pairs with which unauthentication is permissible. In this example, M equals 4,500 x 0.1 = 450. The image processing apparatus 100 calculates the numerical value α of the face similarity with which the frequency of the pairs having a face similarity of less than α is M, and sets α as the threshold value of the face similarity. The frequency distribution 700 includes a subset 702 including M (=450) pairs of face images.

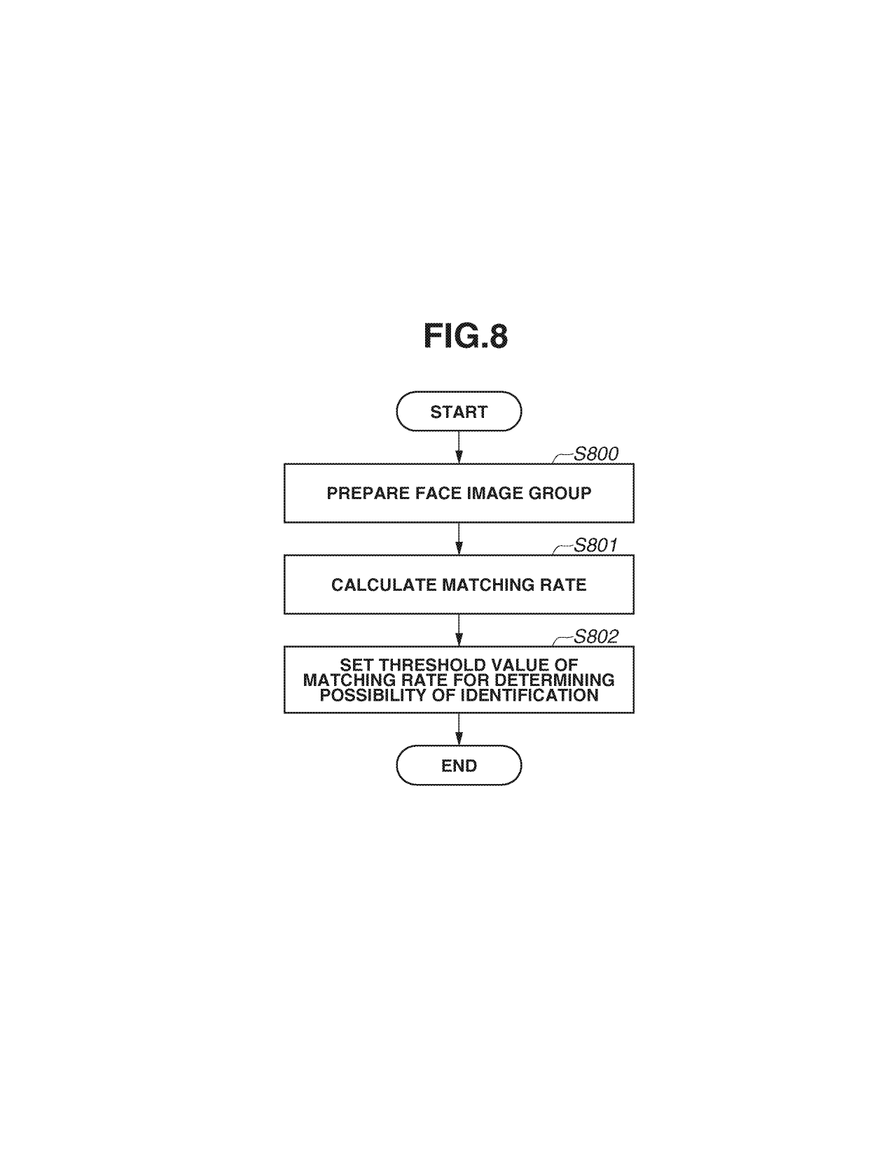

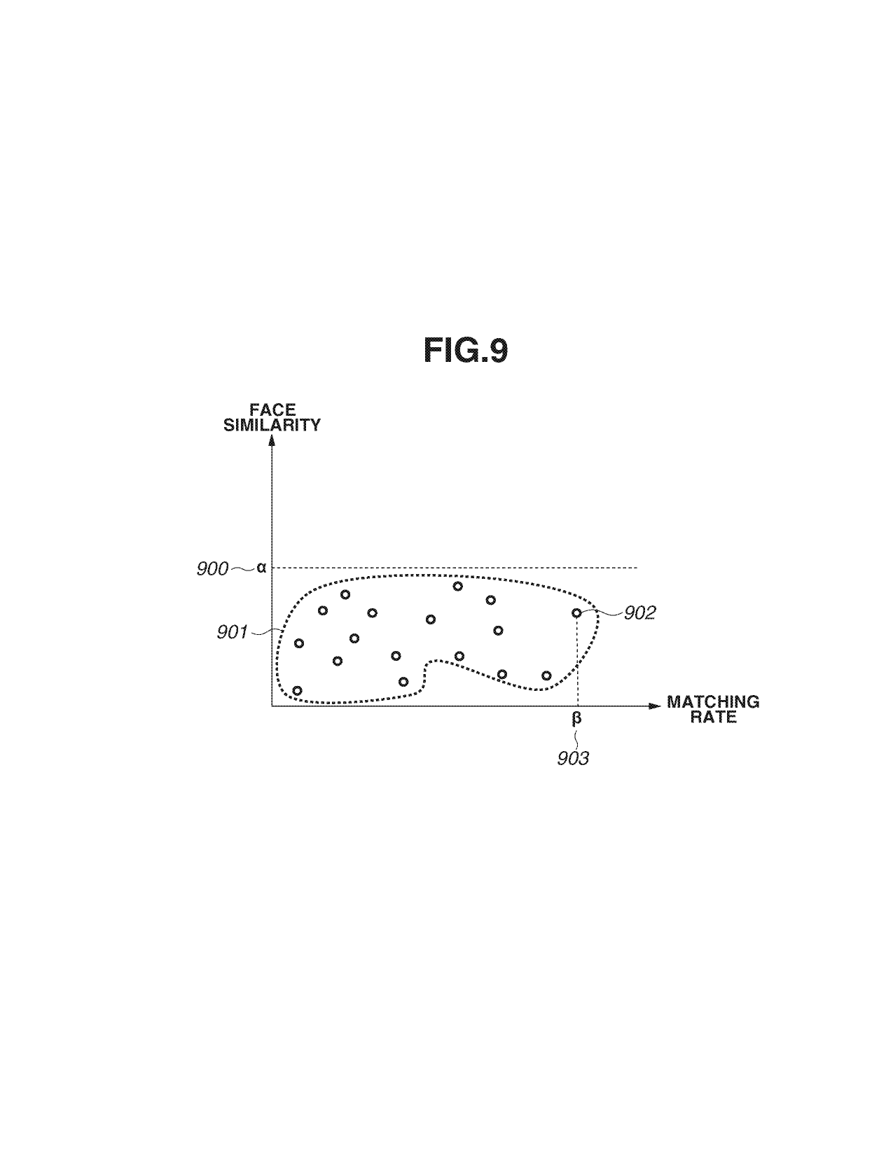

A method for determining the threshold value of the matching rate used in step S204 will be described with reference to FIGS. 8 and 9. FIG. 8 illustrates an example of processing for determining the threshold value, and FIG. 9 illustrates an example of a scatter diagram representing the matching rate and the face similarity.

Turning to FIG. 8, in step S800, the image processing apparatus 100 prepares a face image group. The image processing apparatus 100 selects the face image pairs of which the similarity calculated in step S601 is less than the threshold value α from among the face image pairs of identical persons prepared in step S600, and sets these pairs as a face image group in this processing.

In step S801, the image processing apparatus 100 calculates the matching rate for each of the face image pairs prepared in step S800. The image processing apparatus 100 detects pairs of corresponding points between two different images by using the method described in Non-Patent Document 2, and sets the number of pairs of corresponding points as the matching rate. The image processing apparatus 100 stores the calculated matching rate in the statistics storage unit 110.

In step S802, the image processing apparatus 100 determines, based on the distribution of the matching rates calculated in step S801, the threshold value of the matching rate used to determine that the persons appearing in two different images are possibly an identical person. According to the present embodiment, the image processing apparatus 100 sets the maximum value of the matching rate between face image pairs of an identical person as the threshold value. The threshold value can be determined based on different criteria or a method.

FIG. 9 illustrates an example of a scatter diagram of face image pairs in which the horizontal axis represents the matching rate and the vertical axis represents the face similarity. FIG. 9 illustrates a threshold value α 900 set in step S602, a set 901 of points plotted in the scatter diagram for the pairs subjected to the matching rate calculation in step S801, a point 902 having the highest matching rate out of points included in the set 901, and a matching rate β 903 of the point 902. While the set 901 originally includes 450 points in this example, these points are simplified to 17 points. According to the present embodiment, the image processing apparatus 100 sets the maximum value of the matching rate as the threshold value. Thus, in the example illustrated in FIG. 9, the matching rate β 903 is set as the threshold value used to determine the possibility of identification.

The image-based face authentication system may present guidance for re-imaging to the authentication target person in a case of unauthentication. Examples of causes of unauthentication include a case of a problematic quality of face images of the authentication target person. The face authentication system presents guidance for re-imaging assuming a case of unauthentication, even though the authentication target person is identical to a pre-registered person. Thus, even if the authentication target person is an unregistered person, the image processing apparatus 100 performs re-imaging, possibly resulting in useless re-imaging. In addition, performing the authentication processing using face images captured with re-imaging may possibly cause mis-authentication. Thus, the image processing apparatus 100 performs re-imaging only in a case where the authentication target person is highly likely to be identical to a registered person by using the above-described processing. This enables reducing a risk of useless re-imaging or unnecessary mis-authentication.

### Second Embodiment

The first embodiment uses the dense matching method for densely estimating corresponding points between images to calculate the matching rate between the input face image and a pre-registered face image.

However, it may be difficult to stably detect corresponding points depending on the quality and characteristics of images.

The first embodiment discusses using a method for investigating whether the matching rate between images is less than a threshold value to determine the possibility of identification, and, in a case where the matching rate is less than the threshold value, determining the possibility of identification. In such a case, the image processing apparatus 100 calculates the matching rate between the pairs of prepared images of a number of identical persons, and sets the maximum value of the matching rate as the threshold value. Depending on the quantity and quality of registered images, this method might not accurately determine the possibility that a person appearing in an input face image is identical to a registered person.

The second embodiment is directed to a method different from the dense matching method to calculate the matching rate. The image processing apparatus 100 determines the possibility of registration of the authentication target person in consideration of the matching rate between the image pairs of identical persons as well as the matching rate between the image pairs of different persons and the similarity when subjecting image pairs to the authentication processing. Similar to the first embodiment, the image processing apparatus 100 according to the present embodiment uses the configuration illustrated in FIG. 1. Similar to the first embodiment, the image processing apparatus 100 according to the present embodiment uses the processing illustrated in FIG. 2. Thus, descriptions common to the first embodiment will be omitted. The present embodiment differs from the first embodiment in the processing in steps S203 and S204.

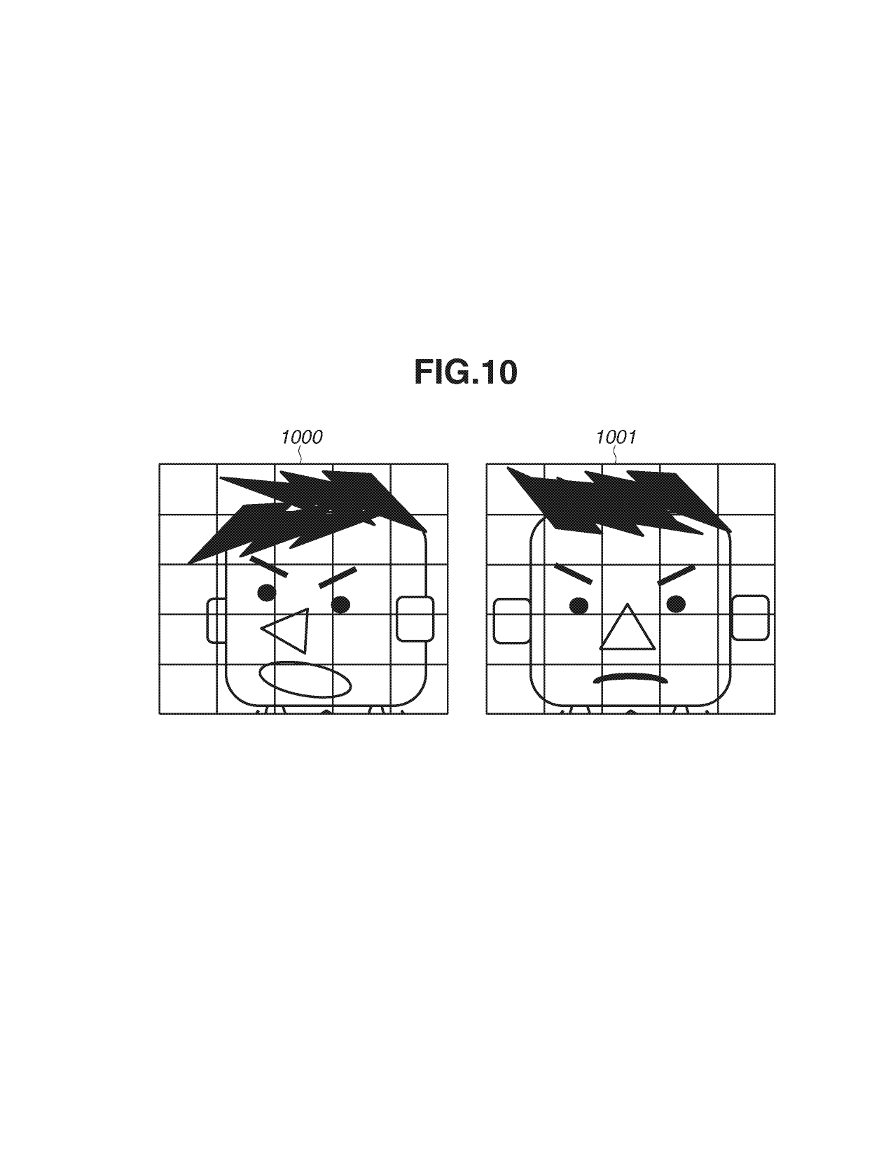

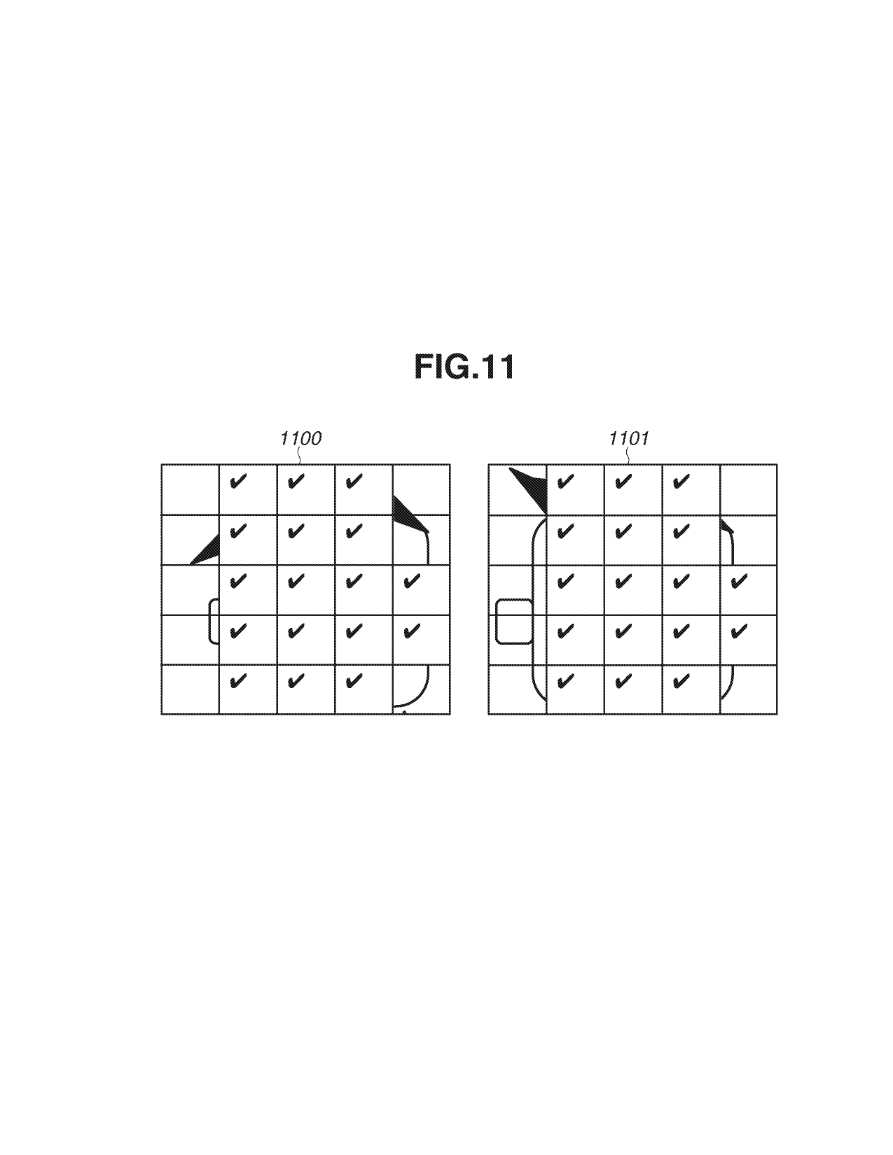

As an example of a method for calculating the matching rate according to the present embodiment, the image processing apparatus 100 divides the input face image of the authentication target person and the registered face images into a plurality of rectangular regions, extracts face-including regions from the rectangular regions, and calculates the matching rate. This means that the image processing apparatus 100 calculates the matching rate by using a part of the face images. The present embodiment uses the method described in "You Only Look Once: Unified, Real-Time Object Detection", in arXiv: 1506.02640 (hereinafter referred to as “Non-Patent Document 3”). Other methods are also applicable. The method if the present embodiment will now be described with reference to FIGS. 10 and 11.

First, the image processing apparatus 100 deforms the input face image and each of the pre-registered face images into a predetermined size to make these images even sized.

Next, the image processing apparatus 100 divides each image into a specific number of rectangular regions. According to the present embodiment, the image processing apparatus 100 divides each image into 5 x 5 rectangular regions. FIG. 10 illustrates an image 1000 as a face image externally input and divided into 5 x 5 rectangular regions, and an image 1001 as a pre-registered face image divided into 5 x 5 rectangular regions.

The image processing apparatus 100 then determines whether each of the 5 x 5 division rectangular regions includes a face.

Finally, the image processing apparatus 100 counts the number of pairs of face-including rectangular regions, at corresponding positions between the two images, and sets the number of pairs of rectangular regions as the matching rate. FIG. 11 illustrates a case where there are 17 pairs of face-including rectangular regions at corresponding positions between the images 1100 and 1101. Referring to FIG. 11, the "checked" rectangular regions are determined to be pairs of face-including rectangular regions at corresponding positions between the two images. In this case, the image processing apparatus 100 counts the number of pairs of face-including rectangular regions at corresponding positions between the two images. The image processing apparatus 100 may count the number of pairs of non-face-including rectangular regions, and sets the number as the matching rate.

As described above, the image processing apparatus 100 can divide images into rectangular regions, extract face-including rectangular regions, and calculate the matching rate by using the extraction result. This method is advantageous in that the authentication target person may know how the position and orientation of the face can be adjusted relative to the camera before performing re-imaging to achieve successful authentication. To prevent the authentication result from being erroneously determined to be an authentication failure even though face images are pre-registered, the number of pairs of rectangular regions needs to be increased to improve the matching rate. For example, the presentation of the information in FIG. 11 enables the authentication target person to know that the number of pairs of rectangular regions is small mainly at both ends of the image. A possible cause of this phenomenon is that the face is inclined with respect to the camera when an image of the authentication target person is captured. Thus, the authentication target person needs to try, for example, orienting the face directly to the camera during imaging.

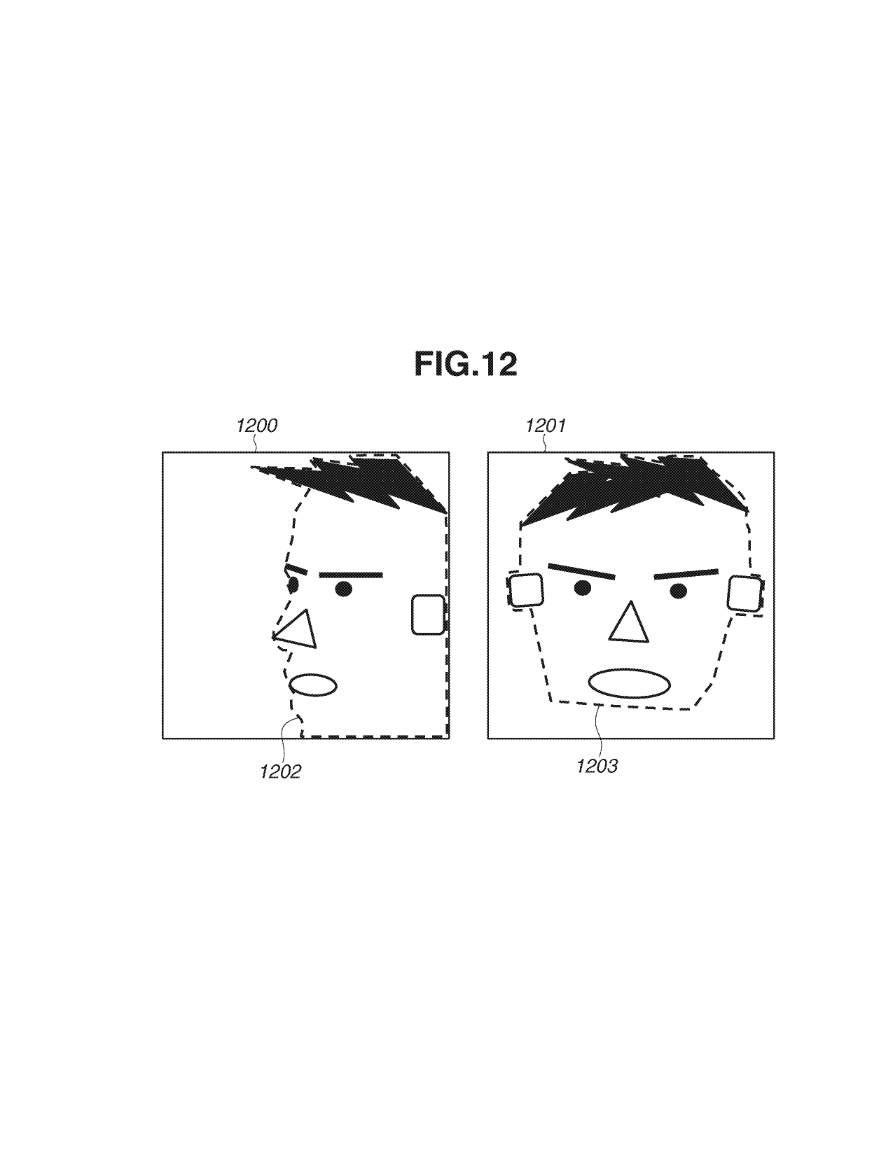

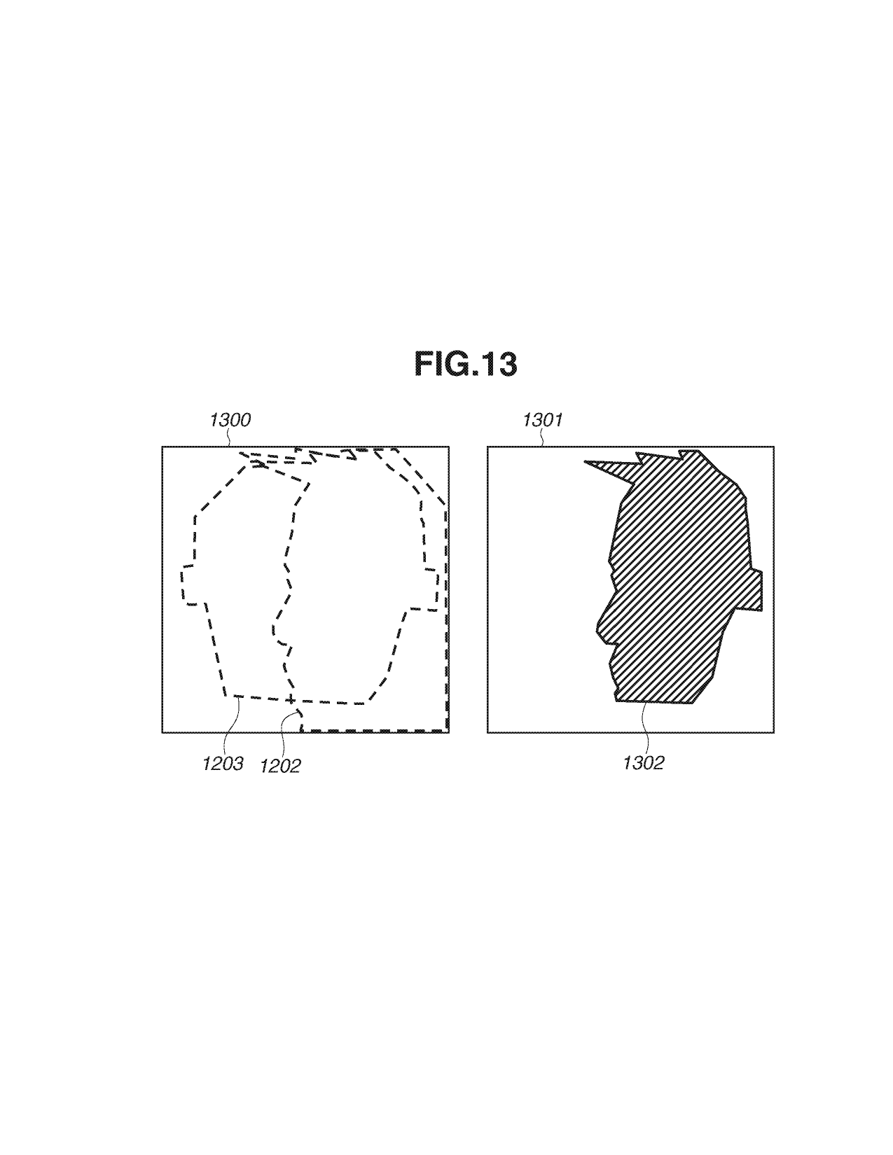

Another method for calculating the matching rate that uses results of extracting face-including pixels will now be described. The present embodiment uses the method described in Kaiming He, Georgia Gkioxari, Piotr Dollar, Ross Girshick, "Mask R-CNN", arXiv: 1703.06870 (hereinafter referred to as “Non-Patent Document 4”). Other methods are also applicable. The present method will be described with reference to FIGS. 12 and 13.

First, the image processing apparatus 100 deforms the input face image and the pre-registered face images into a predetermined size to make these images even sized.

Next, the image processing apparatus 100 processes each of the images by using the method described in Non-Patent Document 4 to calculate the face region in the image. FIG. 12 illustrates an image 1200 as a face image input from the outside and an image 1201 as a pre-registered face image. A region 1202 is a face region detected from the image 1200, and a region 1203 is a face region detected from the image 1201.

Finally, the image processing apparatus 100 overlaps the face regions of different images into one image and sets the number of pixels included in a common region as the matching rate. FIG. 13 illustrates an image 1300 including a region having the same size as the images 1200 and 1201, and the regions 1202 and 1203 drawn in an overlapped way. FIG. 13 also illustrates an image 1301 including a region having the same size as the images 1200 and 1201, and a common region 1302 of the regions 1202 and 1203. In this example, the matching rate refers to the number of pixels included in the common region 1302. The present method is advantageous in that the authentication target person may know how the position and orientation of the face should be adjusted relative to the camera before performing re-imaging to achieve successful authentication. This means that the image processing apparatus 100 may calculate the matching rate by more finely dividing images than the above-described matching method using rectangular regions, enabling to more finely set the threshold value for determining the possibility of identification. The present method enables effectively reducing the occurrence of re-imaging or mis-authentication also for the authentication target person indicating the possibility of identification in the vicinity of the threshold value for determining the possibility of identification.

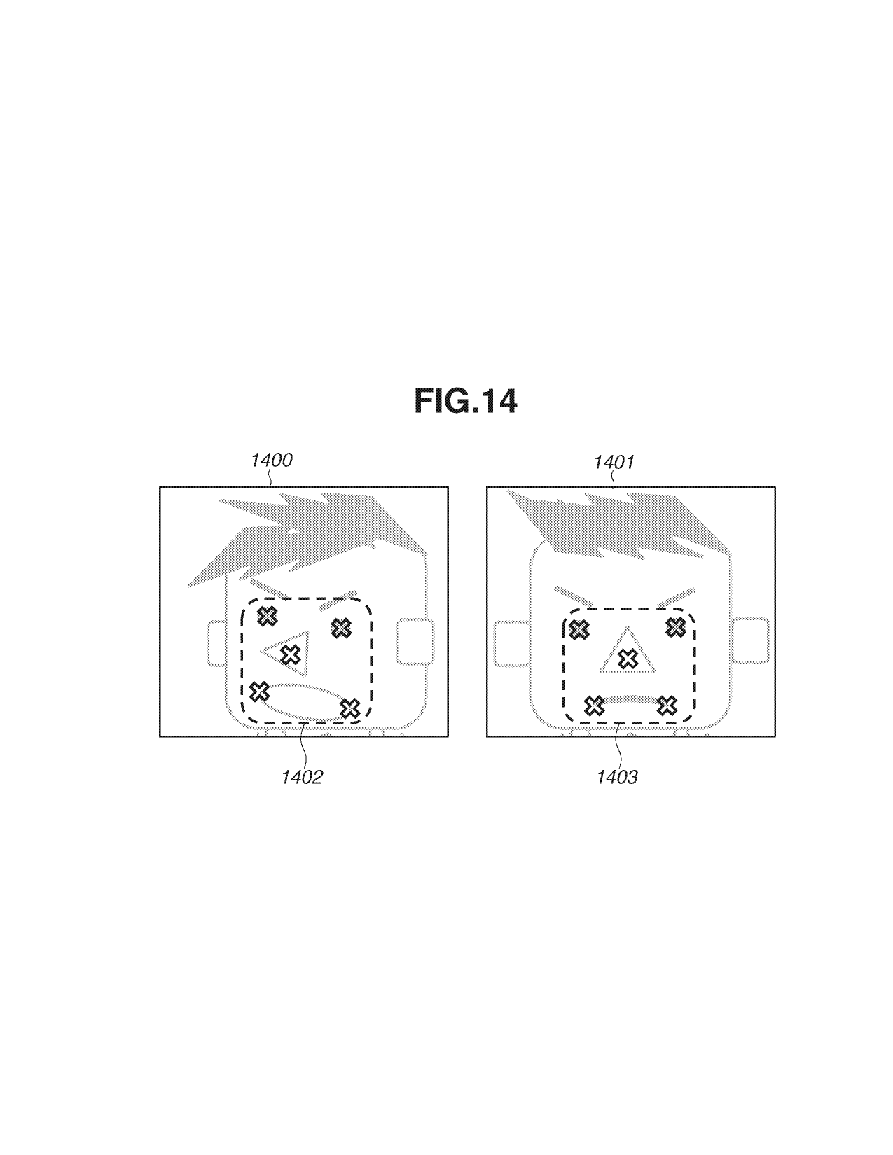

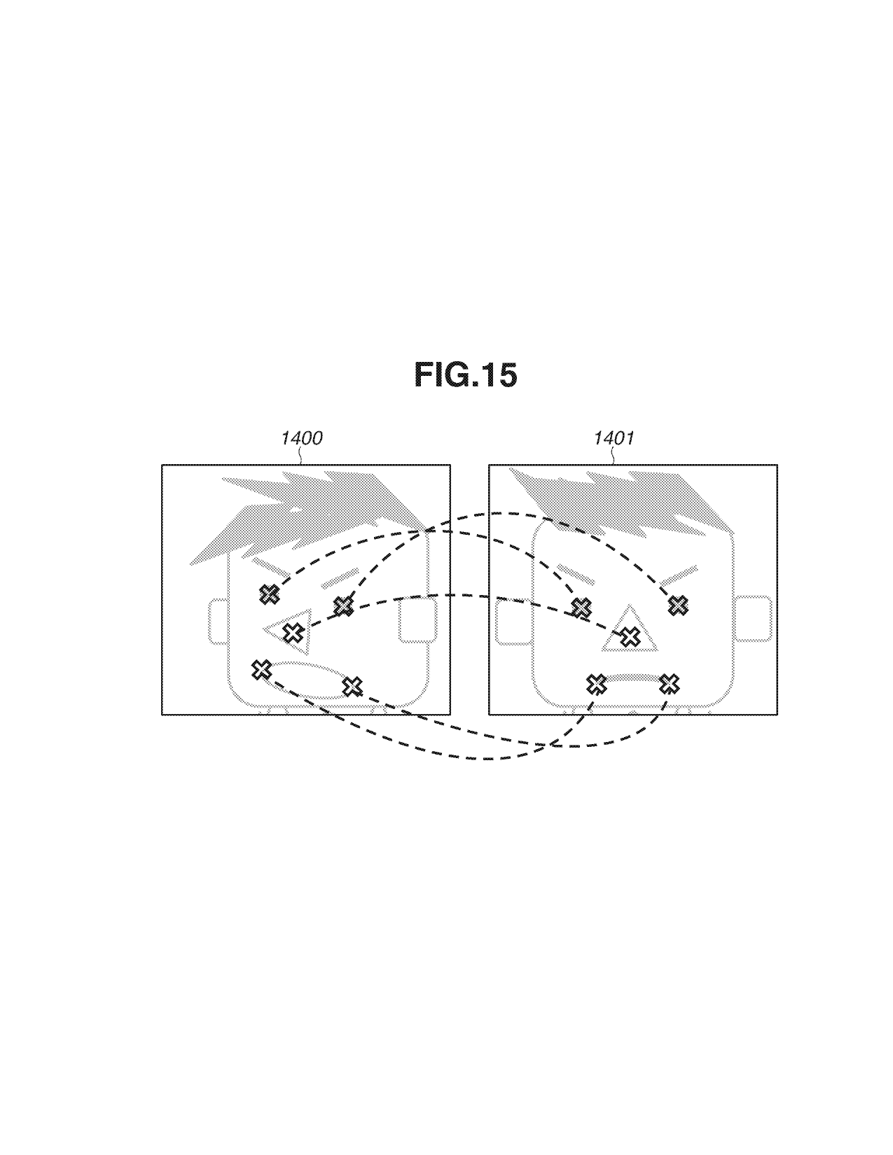

Still yet another method for calculating the matching rate includes using a result of detecting facial organ positions such as the centers of the eyes and both ends of the mouth. The present embodiment uses the method for calculating the matching rate based on differences between three-dimensional distributions of facial organ positions described in Amir Zadeh, Tadas Baltrusaitis, Louis-Philippe Morency "Convolutional Experts Constrained Local Model for Facial Landmark Detection", arXiv: 1611.08657 (Non-Patent Document 5). Other methods can also be applicable. The present method will be described with reference to FIGS. 14 and 15.

First, the image processing apparatus 100 detects facial organ positions based on the input face image and each of the pre-registered face images. The image processing apparatus 100 thereby obtains a point group (hereinafter referred to as a point group 1) detected from the input face image, and a point group (hereinafter referred to as a point group 2) detected from the pre-registered face image.

FIG. 14 illustrates an image 1400 serving as a face image externally input and an image 1401 serving as a pre-registered face image. A point group 1402 is the point group 1 detected from the image 1400, and a point group 1403 is the point group 2 detected from the image 1401. The present embodiment uses five different facial organ positions: the centers of both eyes, the top of the nose, and both ends of the mouth. Thus, each of the point groups 1402 and 1403 include five points. Each of the five points has two-dimensional coordinates on the image and three-dimensional coordinates in the space. Each point also has information about type of the relevant organ point.

Next, the image processing apparatus 100 uses the three-dimensional coordinates of the point groups 1 to obtain a homogeneous transformation matrix for converting the point group 1 to the point group 2 (hereinafter this matrix is referred to as a matrix R12), and calculates the sum of distances between the points of the point group 2 and the points of the point group 1 corresponding to the points of the point group 2 after the conversion (hereinafter this sum is referred to as a sum RS12). FIG. 15 illustrates a result of associating the points in the image 1401 with the points of the same type in the image 1400. The image processing apparatus 100 calculates the matrix R12 based on the result of associating the points illustrated in FIG. 15, converts the point group 1 by using the matrix R12, and then calculates the sum RS12. Finally, the image processing apparatus 100 calculates the reciprocal of the sum RS12 and sets the resultant value as the matching rate.

As described above, the image processing apparatus 100 can calculate the matching rate based on differences between three-dimensional distributions of facial organ positions. This method has an advantage that the authentication target person may know how the facial organ positions can be adjusted before performing re-imaging to achieve successful authentication. To prevent the authentication result from being erroneously determined to be an authentication failure even though face images are pre-registered, relative positions of facial organs in the three-dimensional space needs to be adjusted. For example, the presentation of the information in FIG. 15 enables the authentication target person to know that mainly the positions of both ends of the mouth are different from those in the registered image. A possible cause of this phenomenon is that the mouth is open when an image of the authentication target person is captured. Thus, the authentication target person needs to try, for example, closing the mouth during imaging.

Another method for calculating the matching rate by using facial organ positions includes calculating the matching rate based on differences between two-dimensional distributions of facial organ positions will now be described.

First, the image processing apparatus 100 obtains the point groups 1 and 2 via processing similar to that of the method for calculating the matching rate based on differences between three-dimensional distributions of facial organ positions.

Next, the image processing apparatus 100 uses two-dimensional coordinates of the point groups 1 and 2 to obtain an affine transformation matrix for converting the point group 1 to the point group 2, and calculates the sum of distances between corresponding points after the conversion (hereinafter this sum is referred to as a sum AS12). Finally, the image processing apparatus 100 calculates the reciprocal of the sum AS12 and sets the resultant value as the matching rate. Even when calculating the matching rate based on differences between two-dimensional distributions of facial organ positions, this method is advantageous in that the authentication target person may know how the facial organ positions can be adjusted before performing re-imaging to achieve successful authentication. This is similar to the case of calculating the matching rate based on differences between three-dimensional distributions of facial organ positions. The calculation of an affine transformation matrix based on two-dimensional data enables performing calculation at higher speed than the calculation with a homogeneous transformation matrix based on three-dimensional data.

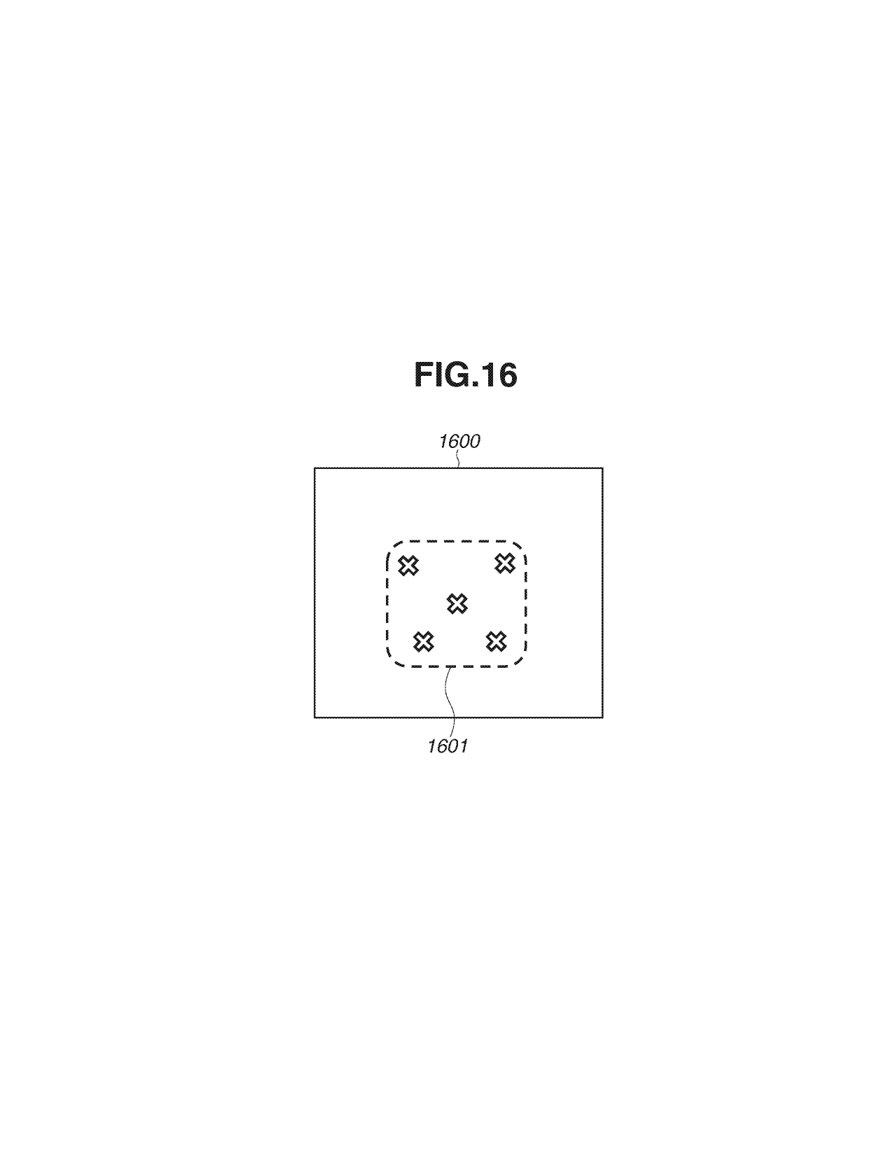

Still yet another method for calculating the matching rate using facial organ positions including normalizing face images and calculating the matching rate based on the amount of positional deviations of corresponding organ positions will be described with reference to FIGS. 16 to 19.

First, the image processing apparatus 100 obtains the point groups 1 and 2 with similar processing to the method for calculating the matching rate based on differences between three-dimensional distributions of facial organ positions.

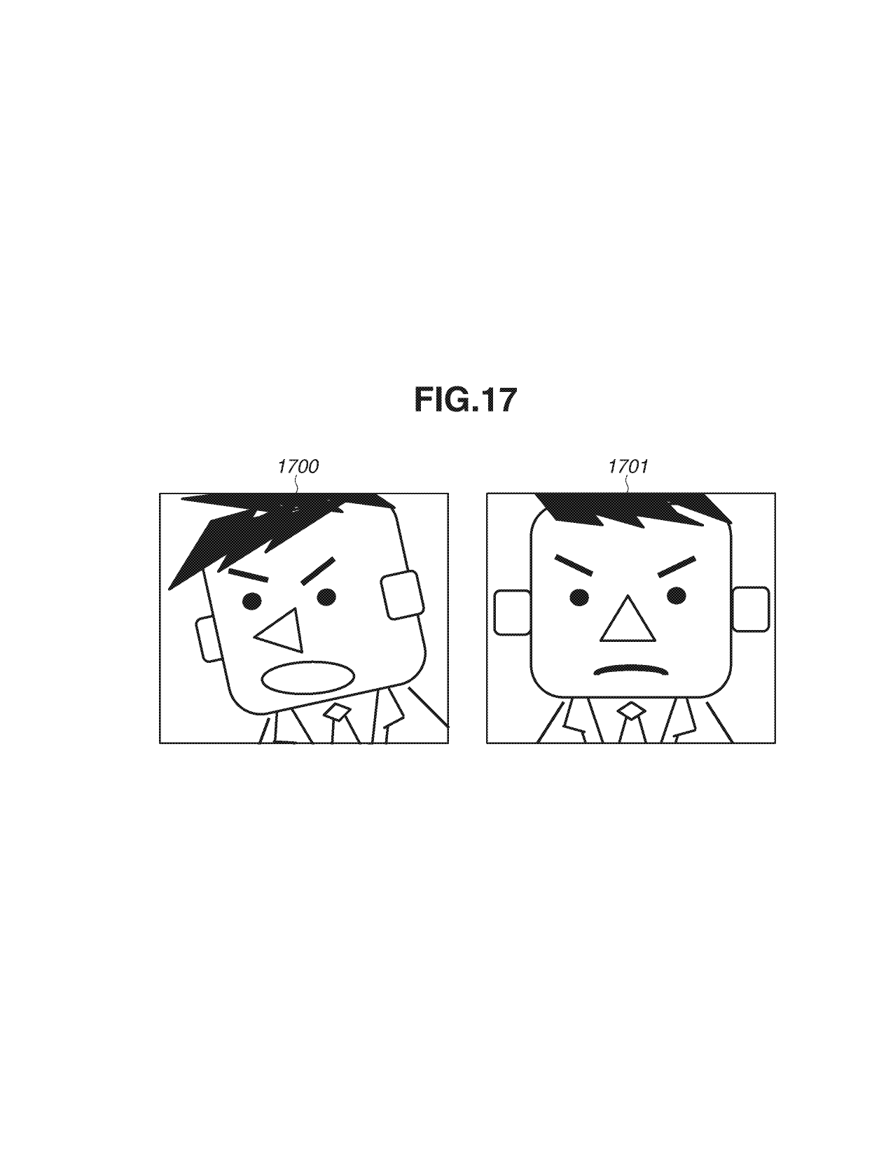

Next, the image processing apparatus 100 generates normalized face images by normalizing the face image externally input and each of the pre-registered face images. A normalized image refers to an image generated by presetting the size of an image and a facial organ target position on the image and then subjecting the image to the affine transform to bring the facial organ position after the conversion close to the target position as much as possible. FIG. 16 illustrates an image 1600 having a preset size, and a set 1601 of facial organ target positions set in the image 1600. FIG. 17 illustrates an image 1700 as a face image input from the outside and then normalized, and an image 1701 as a pre-registered face image normalized.

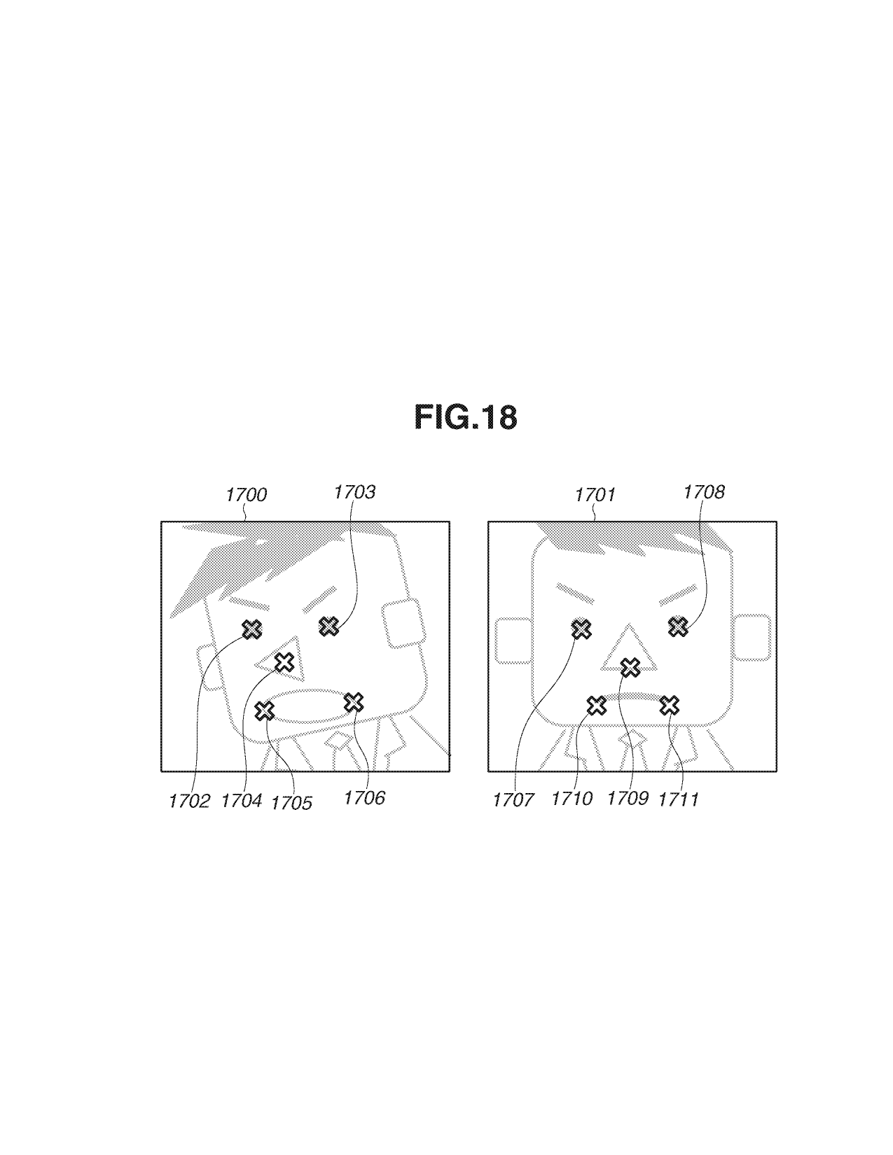

For these two normalized images generated by the normalization, the image processing apparatus 100 calculates the sum of distances between corresponding points (hereinafter this sum is referred to as a sum NS12). Referring to FIG. 18, points 1702, 1703, 1704, 1705, and 1706 indicate organ positions on the image 1700, and points 1707, 1708, 1709, 1710, and 1711 indicate organ positions on the image 1701.

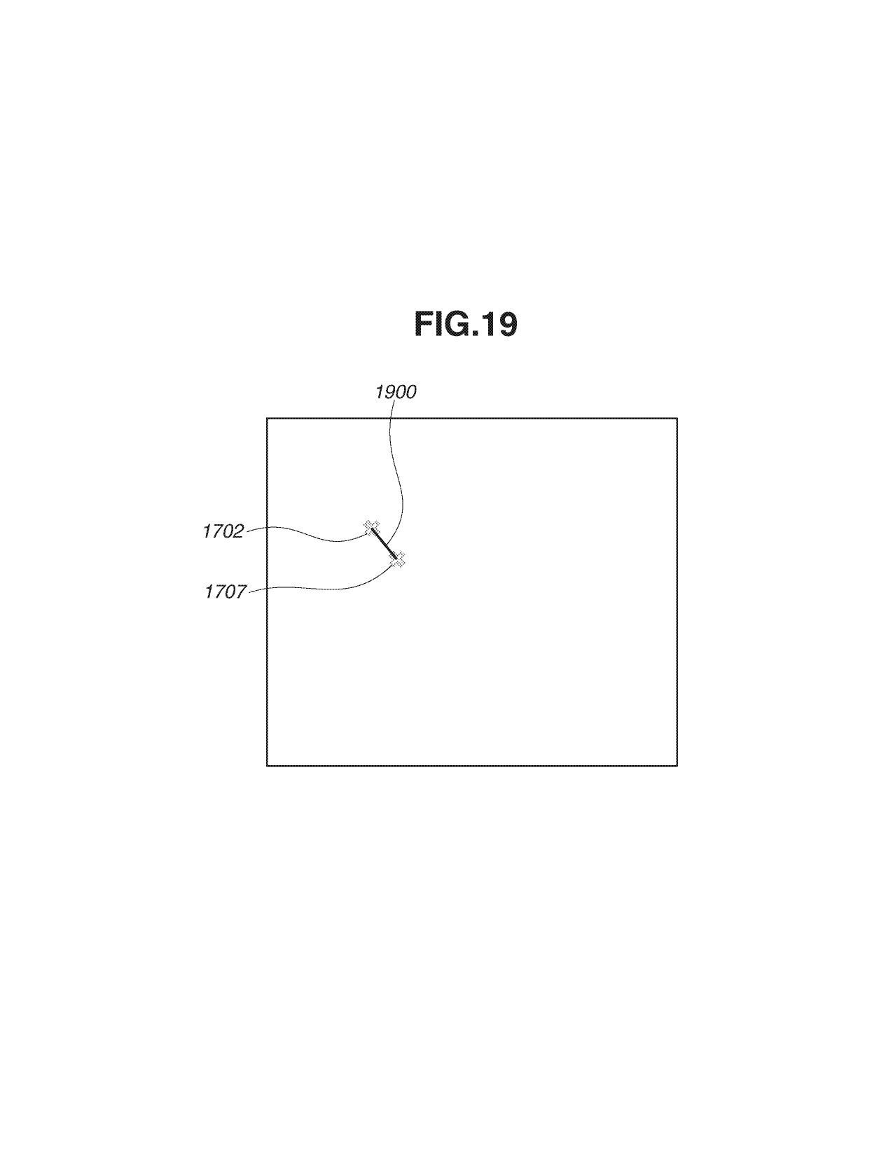

FIG. 19 indicates a result of displaying a point 1702 at the center of the right eye on the image 1700 and a point 1707 at the center of the right eye on the image 1701 on the same image. A line segment 1900 connects the points 1702 and 1707 as corresponding points, and the length of the line segment 1900 equals the distance between the points 1702 and 1707. The image processing apparatus 100 calculates the distances between other corresponding points and sets the sum of each distance (herein after this sum is referred to as a sum NS12). Finally, the image processing apparatus 100 calculates the reciprocal of the sum NS12 and sets the resultant value as the matching rate.

This method is advantageous in that, by comparing the two different normalized images, the authentication target person may intuitively know whether facial organs are suitably detected from the face image externally input. For example, the presentation of the information in FIG. 18 enables the authentication target person to know that the two normalized images have different facial angles since the positions of points mainly detected from the nose of the authentication target person are different. Thus, the authentication target person needs to try, for example, to orient the nose directly to the camera to match the positions of points detected from the nose.

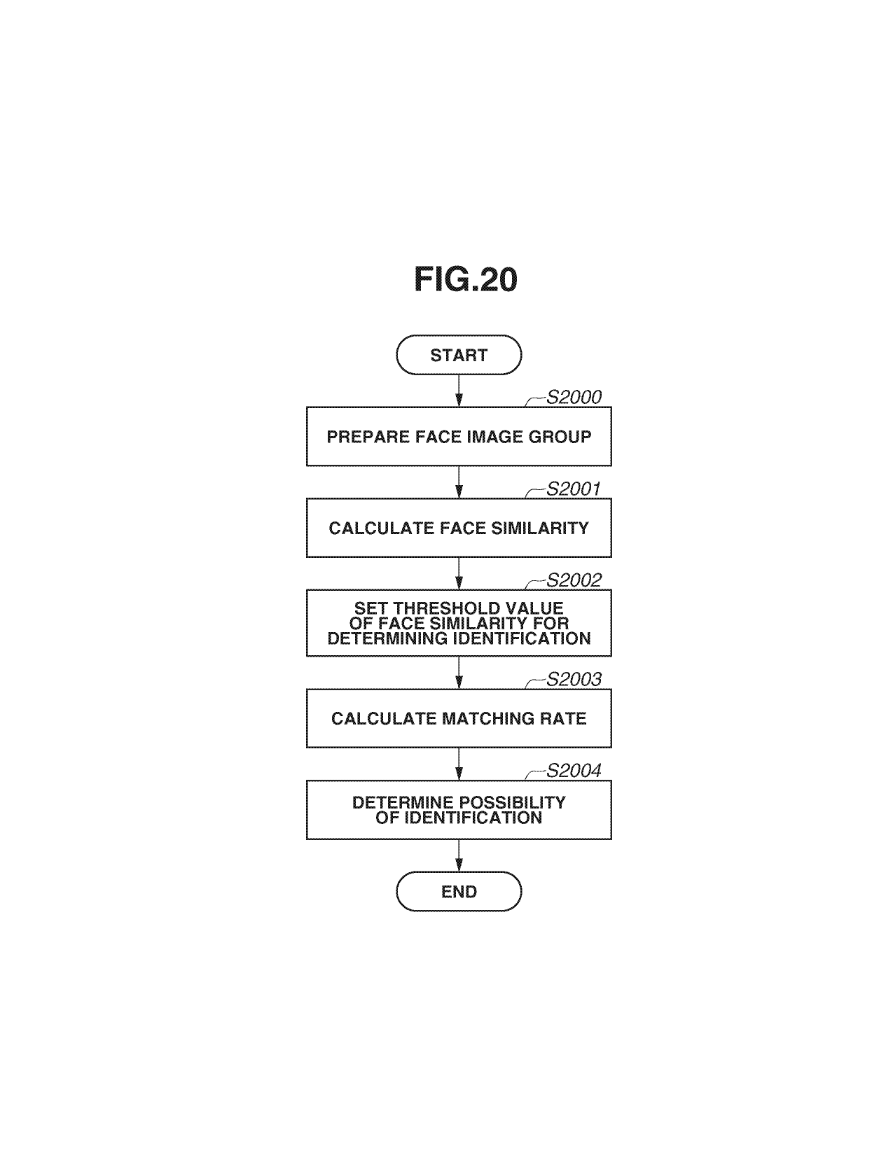

The present embodiment will now be described with respect to a method for determining whether a person appearing in a face image externally input is possibly identical to a pre-registered person. FIG. 20 illustrates an example of detailed processing in step S204 according to the present embodiment.

In step S2000, the image processing apparatus 100 prepares a face image group. For description purposes, the image processing apparatus 100 prepares 10 images for each of 100 persons like step S600.

In step S2001, the image processing apparatus 100 calculates the face similarities based on the face images prepared in step S2000. The image processing apparatus 100 calculates the face similarities by using the method described in Non-Patent Document 1 for each of 4,500 pairs of face images of identical persons and each of 495000 pairs of face images of different persons. The image processing apparatus 100 stores the face similarities in the statistics storage unit 110.

In step S2002, the image processing apparatus 100 sets the threshold value of the face similarity for face authentication. Similar to step S602, the image processing apparatus 100 sets a threshold value α such that the unauthentication rate for the face image pairs of identical persons becomes 0.1.

In step S2003, the image processing apparatus 100 calculates the matching rates based on the face images prepared in step S2000. First, the image processing apparatus 100 selects only pairs of which the similarity calculated in step S2001 is less than the threshold value α from among the face image pairs of identical persons and the face image pairs of different persons that can be generated from the face image group in step S2000. Subsequently, the image processing apparatus 100 calculates the matching rate for each of the selected pairs. The image processing apparatus 100 also stores the calculated matching rates in the statistics storage unit 110.

In step S2004, the image processing apparatus 100 determines whether a person appearing in the face image externally input is possibly identical to a pre-registered person. First, the image processing apparatus 100 generates a 2-class classifier based on the distribution of the matching rates calculated in step S2003, by using a non-linear support vector machine (SVM). The two classes include the class of the image pairs of an identical person and the class of the image pairs of different persons.

Next, the image processing apparatus 100 calculates the matching rate for a pair of the face image externally input and the registered image having the highest similarity. The image processing apparatus 100 processes the values of the similarity and matching rate for this pair by using the 2-class classifier.

In a case where the pair is classified into the class of the images of an identical person, the image processing apparatus 100 determines the possibility of identification. In a case where the pair is classified into the class of the images of different persons, the image processing apparatus 100 does not determine the possibility of identification.

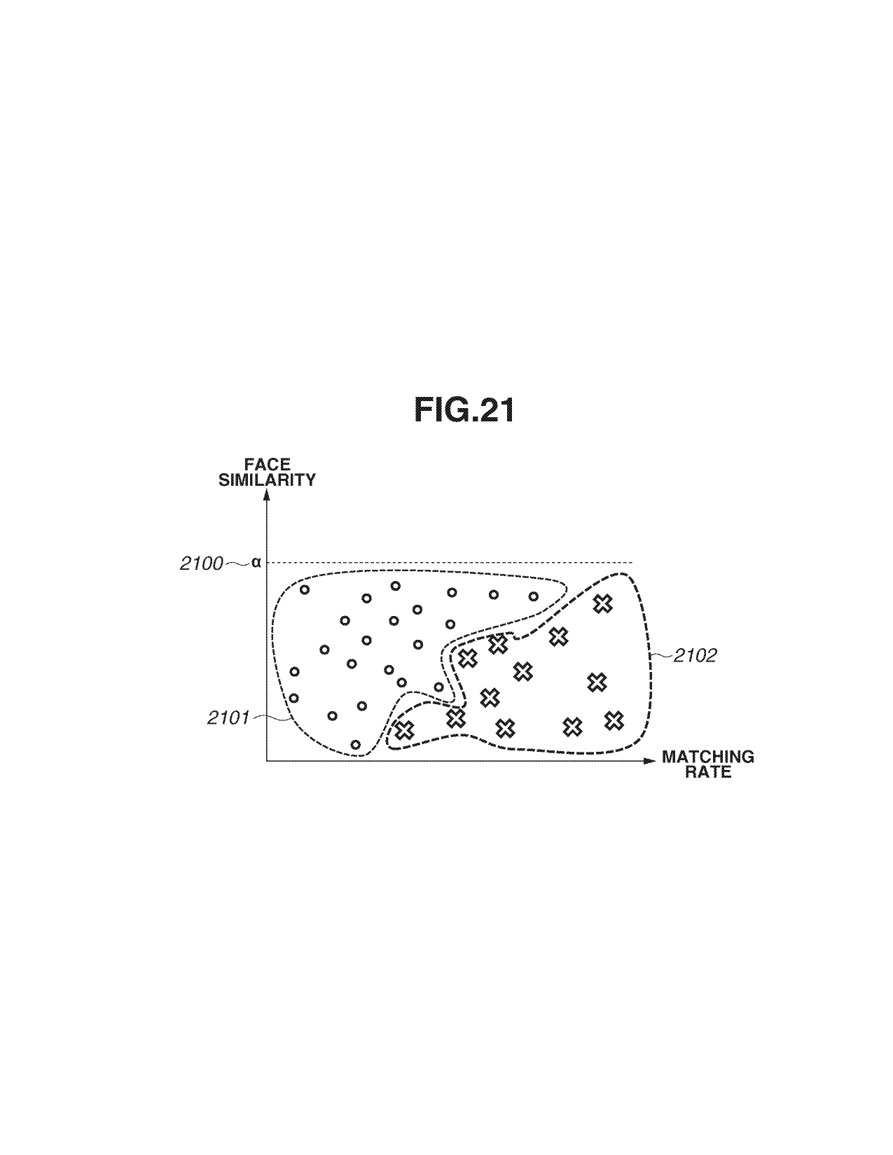

The processing in step S2004 will be described in more detail with reference to FIGS. 21 to 23.

FIG. 21 is a scatter diagram in which the horizontal axis represents the matching rate and the vertical axis represents the face similarity. FIG. 21 illustrates a threshold value α 2100 determined in step S2002, and a set 2101 of points plotted in the scatter diagram for the image pairs of identical persons subjected to the matching rate calculation in step S2003.

FIG. 21 also illustrates a set 2102 of points plotted in the scatter diagram for the data of image pairs of different persons subjected to the matching rate calculation in step S603.

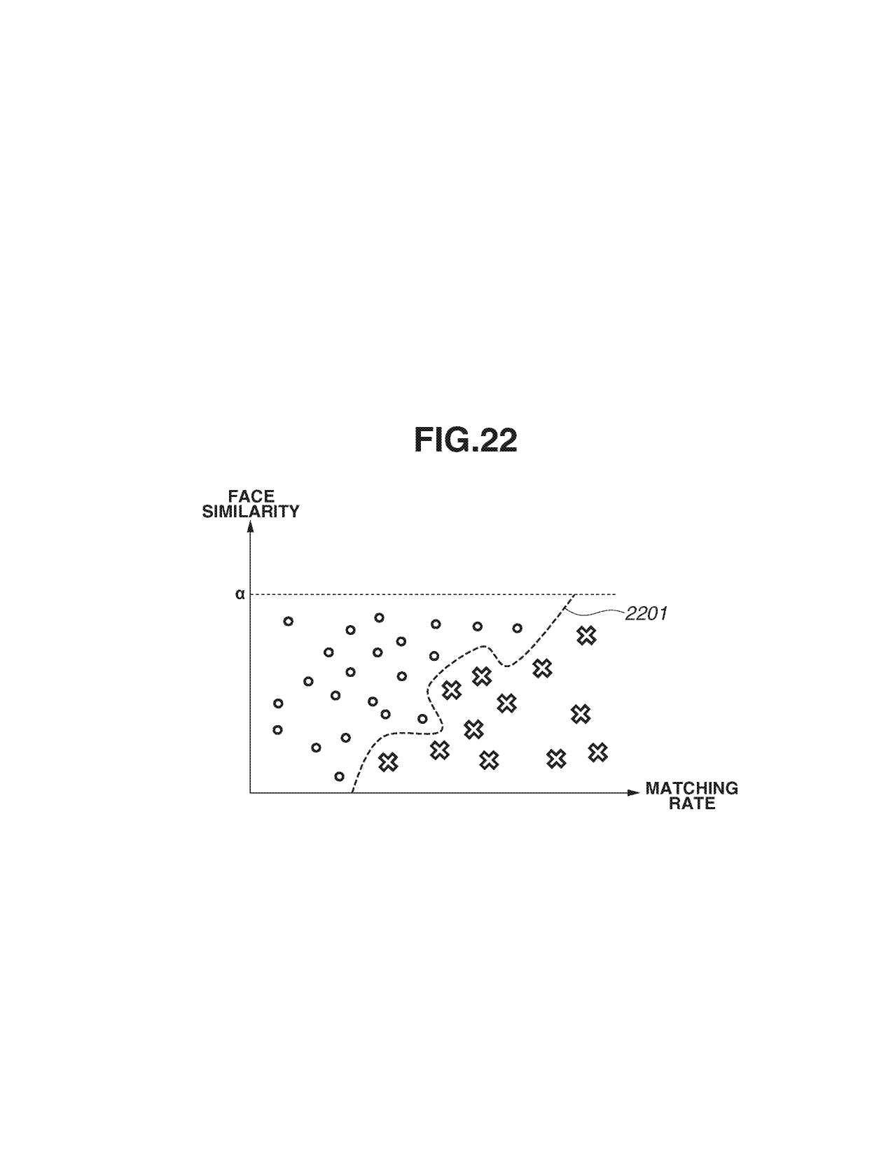

FIG. 22 illustrates an example of the scatter diagram in FIG. 21 in which a class division line 2201 calculated by the non-linear SVM is drawn. The class on the left-hand side of the division line 2201 is the class of the image pairs of an identical person, and the class on the right-hand side of the division line 2201 is the class of the image pairs of different persons.

While the present embodiment uses a non-linear SVM to generate a 2-class classifier, other methods are also applicable. For example, the image processing apparatus 100 can calculate a straight line as a boundary by using a linear SVM. The image processing apparatus 100 can also generate a plurality of classes by using the k averaging method, and set each class as the class of the image pairs of an identical person or the class of the image pairs of different persons.

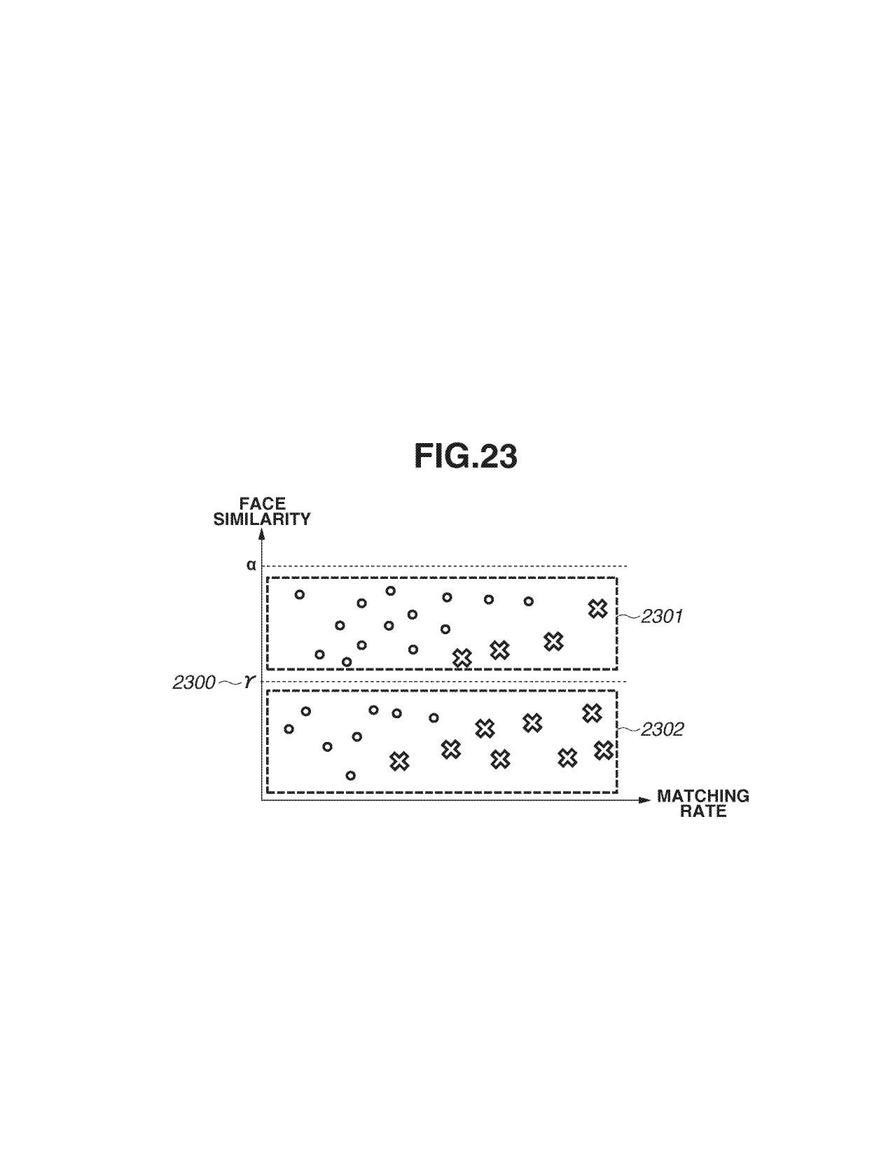

Determination with high accuracy may be difficult depending on the tendency of the distributions of the data of an identical person and the data of different persons. Thus, the image processing apparatus 100 can divide regions in which the face similarity is less than the threshold value α into a plurality of regions, and subject each region to the classification. For example, as illustrated in FIG. 23, the image processing apparatus 100 can also divide regions where the face similarity is less than the threshold value α into two regions 2301 and 2302 by using a new threshold value γ 2300, and then subject each region to 2-class classification.

The above-described method performs the relevant determination by using the similarities and matching rates stored in the statistics storage unit 110. The determination method is not limited thereto. Other methods are also applicable to the relevant determination. For example, the image processing apparatus 100 can use a rule-based determination method via a prior examination of threshold values most suitable for a specific environment in which the face authentication system is used. The image processing apparatus 100 can generate a classifier having learned correlations of distributions of the similarity and matching rate via machine learning in advance, and use the classifier for the relevant determination. The image processing apparatus 100 can generate a classifier by using any one of the above-described methods, and, in a case where the classification performance is subsequently less than a predetermined value, determine that there is no possibility of identification.

The dense matching method for densely estimating corresponding points between images may find it difficult to stably detect corresponding points. The determination method using a threshold value calculated based on the matching rate between the image pairs of identical persons may also find it difficult to determine the possibility of identification at a high accuracy depending on the quantity and quality of registered images. The use of the above-described processing enables stably performing determination at a high accuracy.

### First Modification

The first and the second embodiments have been described with respect to a method for calculating the matching rate with the image having the highest similarity out of the face image externally input and each of the pre-registered face images. In this case, all of the registered face images are captured images of real persons.

The method for using only the image having the highest similarity in the matching rate calculation provides an unstable result of the matching rate calculation, possibly not obtaining the expected result. For example, even when a person appearing in the face image externally input is different from a person appearing in the image having the highest similarity, this method can calculate a high matching rate, possibly resulting in an erroneous determination that there is a possibility of identification. For this reason, the first modification will be described with respect to a method for improving the calculation stability of matching rates by using artificially generated face images.

Similar to the first embodiment, the configuration illustrated in FIG. 1 is used as an example of the image processing apparatus according to the present modification. Similar to the first embodiment, the processing illustrated in FIG. 2 is used as the processing according to the present modification. The present modification differs from the first embodiment in the processing in step S203. Descriptions common to the first embodiment will be omitted, while differences from the first embodiment will be described below.

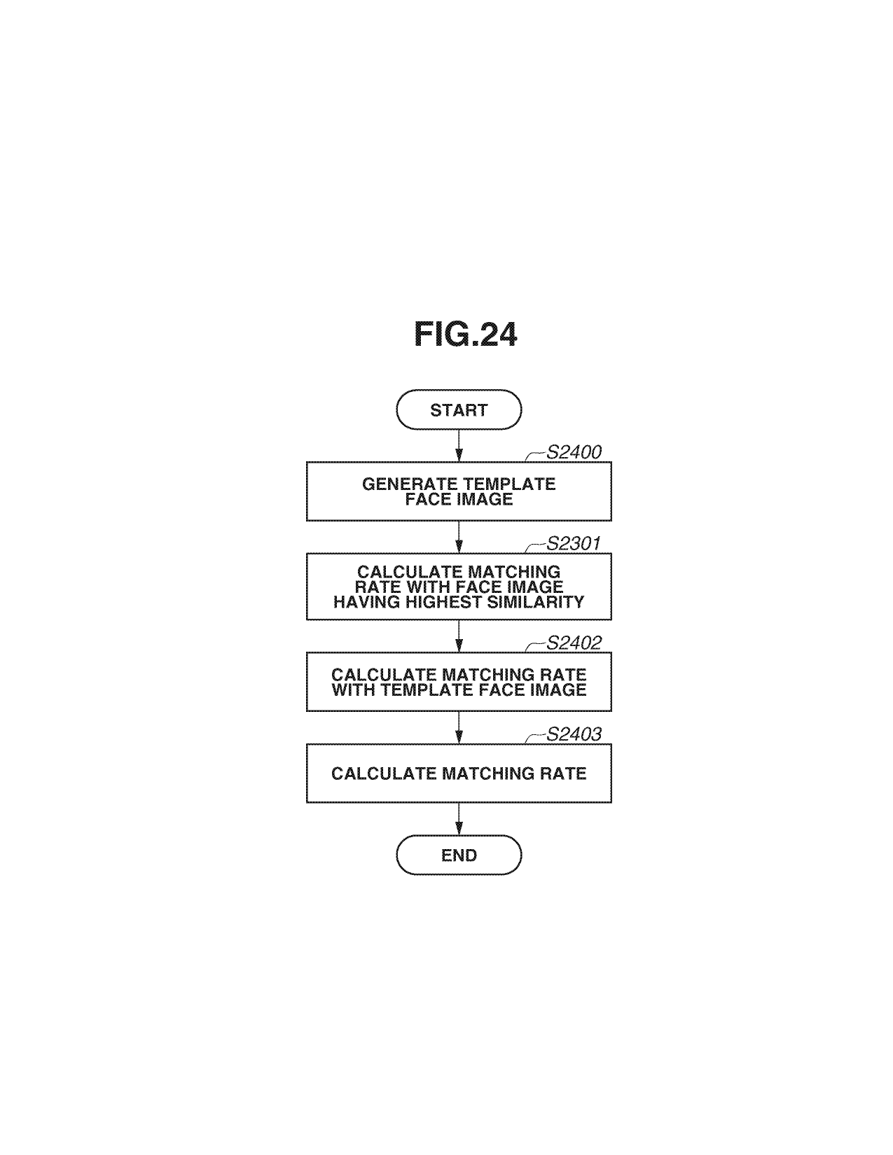

FIG. 24 illustrates processing for calculating the matching rate according to the present modification.

In step S2400, the image processing apparatus 100 generates template face images. According to present modification, the image processing apparatus 100 generates an average luminance value image based on the face images pre-registered in the face image storage unit 106 and uses the average luminance value image as a template face image.

In step S2401, like step S203, the image processing apparatus 100 calculates the matching rate between the input face image and the registered face image having the highest similarity with the input face image.

In step S2402, the image processing apparatus 100 calculates the matching rate between the input face image and the template face image generated in step S2400. Like step S203, the image processing apparatus 100 uses the method described in Non-Patent Document 2 for the matching rate calculation.

In step S2403, the image processing apparatus 100 calculates the average of the matching rate calculated in step S2401 and the matching rate calculated in step S2402. The method for calculating the matching rate is not limited thereto. The image processing apparatus 100 can also use a weighted average of the matching rates calculated in steps S2401 and S2402 as the matching rate to be used to determine whether the authentication target person may possibly be a person of whom face images are registered.

The present modification enables improving the stability of the result of the matching rate calculation.

### Second Modification

According to the first and the second embodiments, the image processing apparatus 100 displays the result of the matching processing performed in the matching rate calculation by using both a face image input from the outside and a pre-registered face image. In a case where a pre-registered face image is seen or captured by a person other than the one appearing in the registered face image, a risk of security may arise because other persons may possibly use the face image as reference information to make successful authentication by spoofing and the like. In a case where the authentication target person is different from the person appearing in a registered face image, a problem of privacy may also arise. For this reason, the method for displaying a pre-registered face image may be changed. An example of a method for not directly displaying a face image will be described below as a modification.

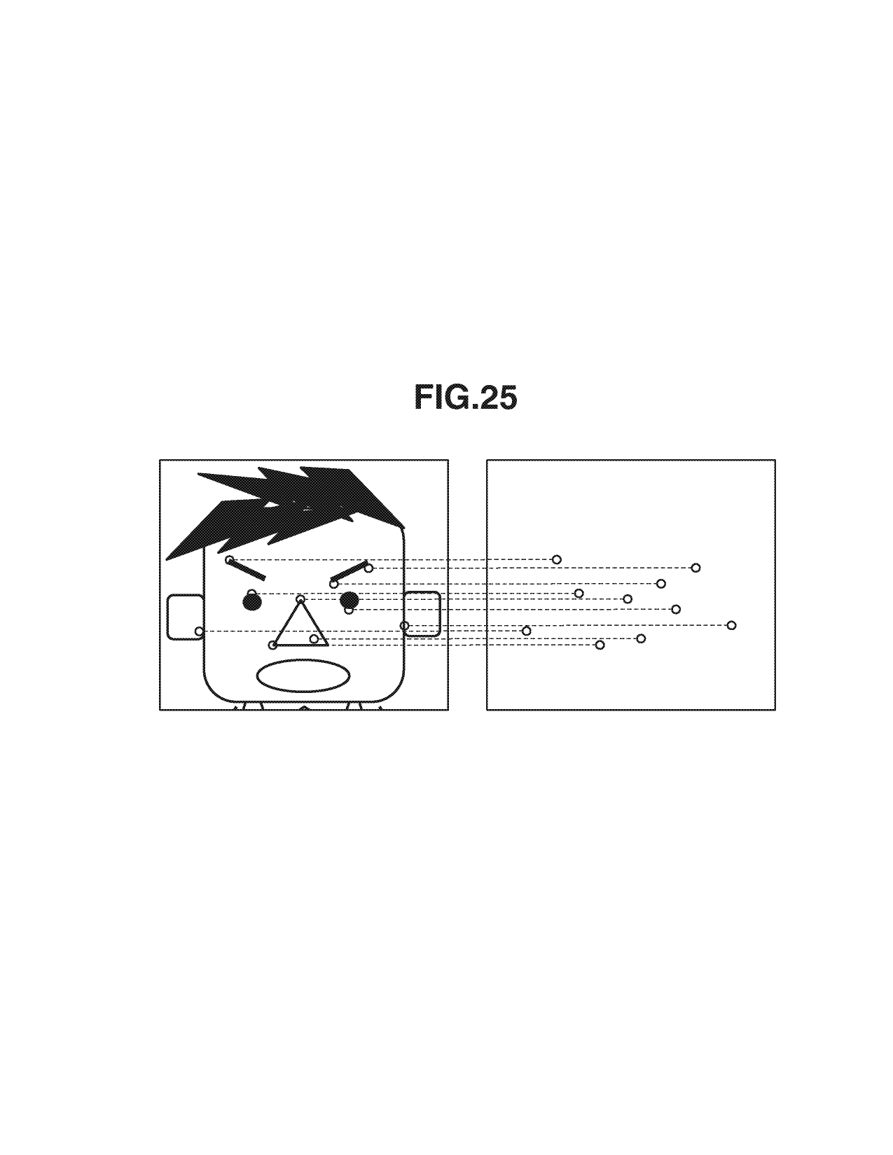

FIG. 25 illustrates an example of a method for displaying the matching result according to the second modification. The left side drawing in FIG. 25 is a face image externally input. For a pre-registered face image, the method displays only the frame line of the image as illustrated in the right-side drawing in FIG. 25. The method displays the matching result without displaying the image itself.

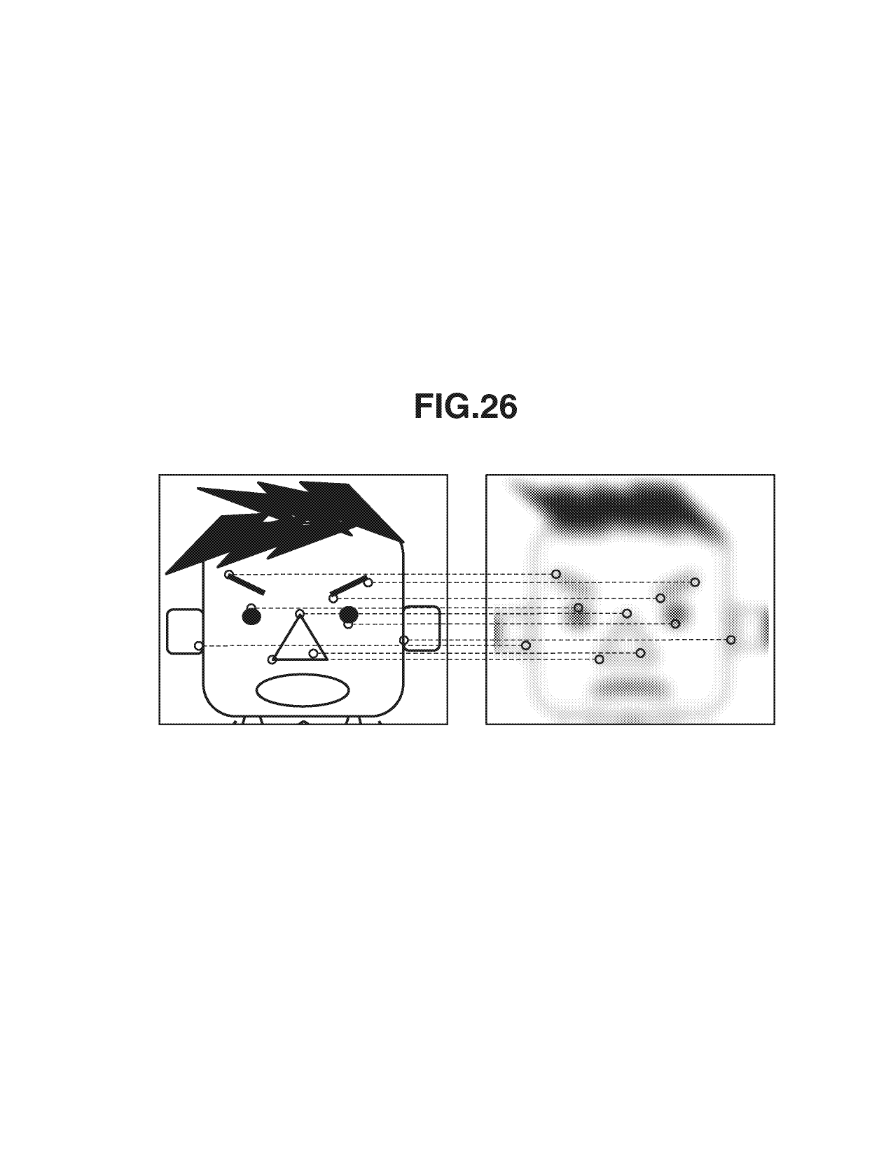

The image processing apparatus 100 can process the pre-registered face image before displaying the matching result. For example, as illustrated in FIG. 26, the image processing apparatus 100 can display the face image externally input on the left-hand side the pre-registered face image in a blurred state on the right-hand side, and the matching result.

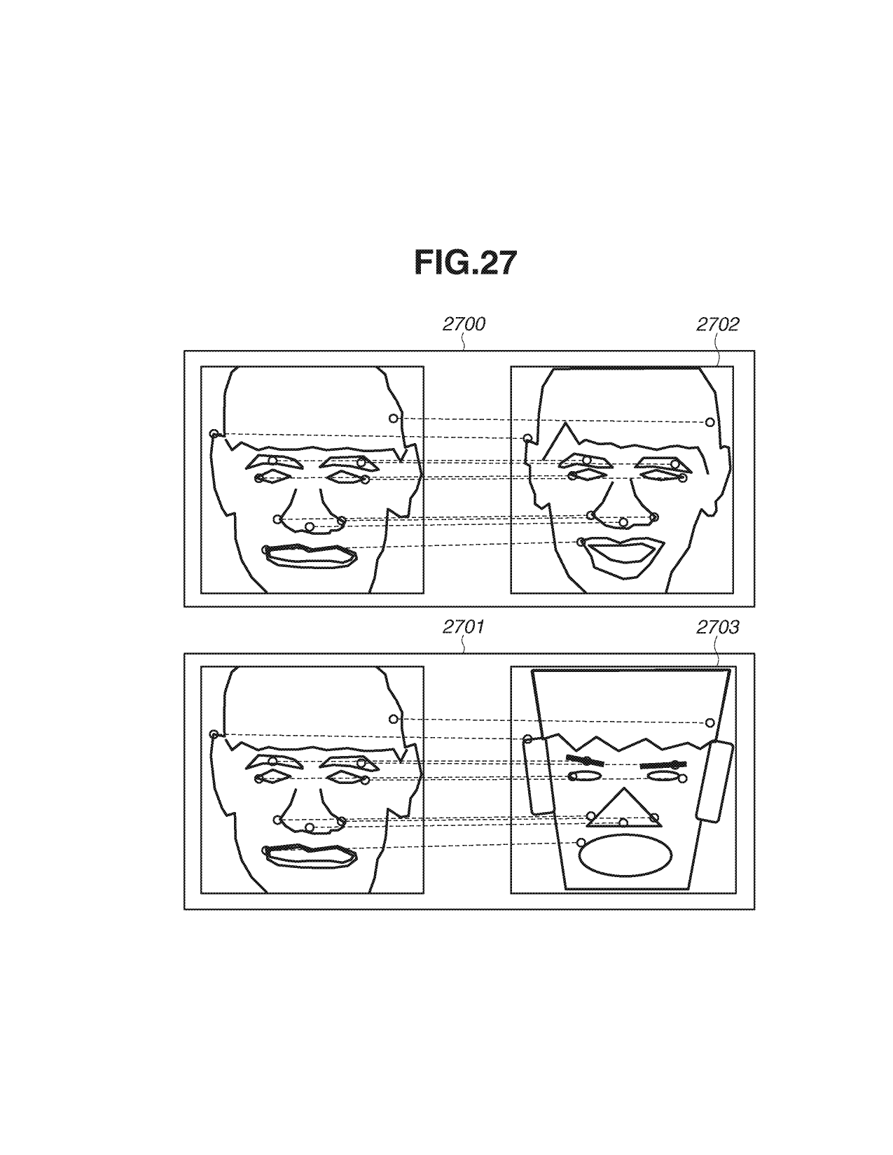

As illustrated in FIG. 27, the image processing apparatus 100 can display the matching result by using an illustration based on a pre-registered face image. FIG. 27 illustrates a matching result 2700 using the method according to the first embodiment. More specifically, the left side drawing of the matching result 2700 in FIG. 27 is an input face image and the right-side drawing is the pre-registered face image. FIG. 27 also illustrates a matching result 2701 by using an illustration 2703 based on a pre-registered face image 2702.

When displaying the matching result, the possibility of authentication by different persons by spoofing and the like can be reduced by not directly displaying the registered face image in such a way.

### Third Modification

According to the first and the second embodiments, the image processing apparatus 100 performs step S201 of face authentication processing, and, only when the face authentication processing fails, the image processing apparatus 100 performs step S203 of matching rate calculation processing.

The image processing apparatus 100 can also calculate the matching rate without performing the determination processing in step S202. The image processing apparatus 100 can obtain the data of the matching rate and the matching result for the successful face authentication processing by calculating the matching rate each time the face authentication processing is performed regardless of whether the face authentication processing is successful. Using the obtained data to set the threshold value for the matching rate enables determining the possibility of identification at high accuracy.

The image processing apparatus 100 can also perform the authentication and the determination of the possibility of identification according to the first embodiment as preprocessing, and perform more detailed and more accurate face authentication in the following stage. In a conventional face authentication system in which a plurality of images is registered for each person, the image processing apparatus 100 can perform the detailed and accurate face authentication processing by giving priority to a registered image having a high matching rate with an input image.

### Fourth Modification

According to the first and the second embodiments, the image processing apparatus 100 performs the face authentication processing and then performs the calculation of the matching rate. Performing the face authentication processing for a large number of registered face images may prolong the execution time of the face authentication processing. Thus, the image processing apparatus 100 performs the calculation of the matching rate before the face authentication processing, and then select images to be subjected to the face authentication processing based on the value of the matching rate. In this case, the image processing apparatus 100 performs the face authentication processing based on the registered face images selected by the matching rate, and, when the face authentication processing fails, the image processing apparatus 100 determines the possibility of identification by the matching rate. The image processing apparatus 100 may also select images based on the value of the matching rate in the second face authentication processing for face images obtained in re-imaging according to the possibility of identification.

The present modification enables reducing the occurrence of useless re-imaging and mis-authentication, as well as shortening the time of the face authentication processing.

### Other Embodiments

The present disclosure is also implemented by performing the following processing. More specifically, software (program) for implementing the functions of the above-described embodiments is supplied to a system or apparatus via a network or various types of storage media, and a computer (or central processing unit (CPU), micro processing unit (MPU), or the like) of the system or apparatus reads and executes the program.

The above-described embodiments are to be considered as illustrative in embodying the present disclosure, and are not to be interpreted as restrictive on the technical scope of the present disclosure. The present disclosure may be embodied in diverse forms without departing from the technical concepts or essential characteristics thereof.

The present disclosure makes it possible to reduce the occurrence of re-imaging and mis-authentication when the authentication results in unauthentication.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-185006, filed October 21, 2024, which is hereby incorporated by reference herein in its entirety.

What is claimed is:

1. An information processing apparatus comprising:
at least one memory storing instructions; and
at least one processor that, when executing the instructions, causes the information processing apparatus to:
register a face image of a person;
perform authentication to authenticate a person using an input face image and the registered face image;
calculate a matching rate between the input face image and the registered face image;
determine, based on a result of the authentication and the matching rate, whether a possibility exists that a person in the input face image is identical to a person in the registered face image; and
output information corresponding to a result of the determination.

2. The information processing apparatus according to claim 1, wherein, in a case it is determined that the possibility exists, the information processing apparatus outputs information based on a result of matching processing for calculating the matching rate.

3. The information processing apparatus according to claim 2, wherein the information processing apparatus outputs the input face image.

4. The information processing apparatus according to claim 2, wherein the information processing apparatus does not output the registered face image.

5. The information processing apparatus according to claim 2, wherein the information processing apparatus outputs a processed image of the registered face image.

6. The information processing apparatus according to claim 1, wherein, in a case where it is determined that the possibility does not exist, the information processing apparatus does not output a result of a matching processing for calculating the matching rate.

7. The information processing apparatus according to claim 1, wherein, in a case where the person is not authenticated, the information processing apparatus calculates the matching rate.

8. The information processing apparatus according to claim 1, wherein the information processing apparatus performs the determination by using a value based on a similarity between a pair of a face image of a certain person and another face image of the certain person, and the similarity between the face image of the certain person and a face image of a person different from the certain person.

9. The information processing apparatus according to claim 8, wherein the information processing apparatus determines whether the determination is possible based on the matching rate and the value.

10. The information processing apparatus according to claim 1, wherein the information processing apparatus performs the determination using a classifier generated via machine learning.

11. The information processing apparatus according to claim 1, wherein the information processing apparatus performs the determination based on a magnitude relation between the matching rate and a predetermined threshold value.

12. The information processing apparatus according to claim 11, wherein, in a case where the matching rate is less than the predetermined threshold value, the information processing apparatus determines whether the possibility exists.

13. The information processing apparatus according to claim 1,
wherein the information processing apparatus stores an artificially generated face image, and
wherein the information processing apparatus calculates the matching rate based on the artificially generated face image, the input face image, and the registered face image.

14. The information processing apparatus according to claim 1, wherein the information processing apparatus calculates the matching rate based on a number of pairs of points detected by a dense matching method.

15. The information processing apparatus according to claim 1, wherein the information processing apparatus calculates the matching rate based on a part of the input face image.

16. The information processing apparatus according to claim 1, wherein the information processing apparatus calculates the matching rate based on a result of detecting organ positions in the input face image.

17. A method for an information processing apparatus, the method comprising:
registering a face image of a person;
performing authentication to authenticate a person using an input face image and the registered face image;
calculating a matching rate between the input face image and the registered face image;
determining, based on a result of the authentication and the matching rate, whether a possibility exists that a person in the input face image is identical to a person in the registered face image; and
outputting information corresponding to a result of the determination.

18. A non-transitory computer-readable storage medium storing a program for causing an information processing apparatus to execute a method, the method comprising:
registering a face image of a person;
performing authentication to authenticate a person using an input face image and the registered face image;
calculating a matching rate between the input face image and the registered face image;
determining, based on a result of the authentication and the matching rate, whether a possibility exists that a person in the input face image is identical to a person in the registered face image; and
outputting information corresponding to a result of the determination.
